(19) United States
(12) Patent Application Publication
(10) Pub. No.: US 2023/0400847 A1
(43) Pub. Date: Dec. 14, 2023

(54) PREDICTIVE MAINTENANCE FOR SEMICONDUCTOR MANUFACTURING EQUIPMENT

(71) Applicant: Lam Research Corporation, Fremont, CA (US)

(72) Inventors: Jian Guo, Tigard, OR (US); Sassan Roham, San Ramon, CA (US); Kapil Sawlani, Ann Arbor, MI (US); Xiaoqiang Jin, Tigard, OR (US); Michal Danek, Cupertino, CA (US); Brian Joseph Williams, Tigard, OR (US); Natan Solomon, Sunnyvale, CA (US)

(21) Appl. No.: 18/251,977

(22) PCT Filed: Nov. 9, 2021
(86) PCT No.: PCT/US2021/058550

§ 371 Date: May 5, 2023

Related U.S. Application Data
(60) Provisional application No. 63/113,133, filed on Nov. 12, 2020.

(51) Int. Cl. G05B 23/02

(52) U.S. Cl. CPC G05B 23/0283; G05B 23/0227; G05B 23/0278; G05B 23/0281

(57) ABSTRACT

Various embodiments herein relate to systems and methods for predictive maintenance for semiconductor manufacturing equipment. In some embodiments, a predictive maintenance system includes a processor that is configured to: receive offline data that indicates historical operating conditions and historical manufacturing information corresponding to manufacturing equipment that conducts a manufacturing process; calculate predicted equipment health status information by using a trained model that takes the offline data as an input; receive real-time data that indicates current operating conditions of the manufacturing equipment; calculate estimated equipment health status information by using the trained model that takes the real-time data as an input; calculate adjusted equipment health status information by combining the predicted equipment health status information and the estimated equipment health status information; and present the adjusted equipment health status information that includes an expected remaining useful life (RUL) of at least one component of the manufacturing equipment.

### INCORPORATION BY REFERENCE

A PCT Request Form is filed concurrently with this specification as part of the present application. Each application that the present application claim benefit of or priority to as identified in the concurrently filed PCT Request Form is incorporated by reference herein in its entirety and for all purposes.

### BACKGROUND

Semiconductor equipment that is used for manufacturing semiconductor devices can be difficult to maintain, because semiconductor equipment can include hundreds of components each with many different failure points, and because system and component setpoints can drift over time due to operation of the equipment. Maintenance work is often identified manually or with only limited information. In some cases, because current maintenance identification techniques may cause equipment problems to be identified too late, significant equipment downtimes, and costly repair work result.

The background description provided herein is for the purposes of generally presenting the context of the disclosure. Work of the presently named inventors, to the extent it is described in this background section, as well as aspects of the description that may not otherwise qualify as prior art at the time of filing, are neither expressly nor implicitly admitted as prior art against the present disclosure.

### SUMMARY

Disclosed herein are methods and systems for predictive maintenance for semiconductor manufacturing equipment.

In accordance with some embodiments of the disclosed subject matter, a predictive maintenance system is provided, which comprises: a memory; and a processor that, when executing computer-executable instructions stored in the memory, is configured to: receive offline data that indicates historical operating conditions and historical manufacturing information corresponding to manufacturing equipment that conducts a manufacturing process; calculate predicted equipment health status information associated with the manufacturing equipment by using a trained model that takes the offline data as an input; receive real-time data that indicates current operating conditions and current manufacturing information corresponding to the manufacturing equipment; calculate estimated equipment health status information associated with the manufacturing equipment by using the trained model that takes the real-time data as an input; calculate adjusted equipment health status information associated with the manufacturing equipment by combining the predicted equipment health status information calculated based on the offline data and the estimated equipment health status information calculated based on the real-time data; and present the adjusted equipment health status information, wherein the adjusted equipment health status information includes an expected remaining useful life (RUL) of at least one component of the manufacturing equipment.

In some embodiments, the offline data that indicates historical operating conditions and the real-time data that indicates current operating conditions comprises data received from one or more sensors of the manufacturing equipment.

In some embodiments, the model is trained using physics-based simulation data.

In some embodiments, the simulation data comprises estimated data at a first spatial location of the manufacturing equipment that is estimated based on measured sensor data at one or more other spatial locations of the manufacturing equipment at which physical sensors are located.

In some embodiments, the estimated data is an interpolation of the measured sensor data.

In some embodiments, the model is trained using metrology data associated with substrates comprising electronic devices fabricated using the manufacturing process.

In some embodiments, the processor is further configured to extract features of the offline data that indicates historical operating conditions and of the real-time data that indicates current operating conditions, and wherein the trained model takes the extracted features as inputs.

In some embodiments, the processor is further configured to: detect an anomalous condition of the manufacturing equipment based on the real-time data that indicates current operating conditions; and in response to detecting the anomalous condition of the manufacturing equipment, identify a type of failure associated with the manufacturing equipment.

In some embodiments, detecting the anomalous condition of the manufacturing equipment is based on a comparison of the real-time data that indicates current operating conditions and the offline data that indicates historical operating conditions.

In some embodiments, identifying the type of failure associated with the manufacturing equipment comprises classifying the real-time data that indicates current operating conditions using a historical failure database.

In some embodiments, identifying the type of failure associated with the manufacturing equipment comprises classifying the real-time data that indicates current operating conditions using physics-based simulation data.

In some embodiments, the processor is further configured to: identify a modification of the current operating conditions of the manufacturing equipment and a likelihood that the modification in the current operating conditions will change the expected remaining lifetime of the at least one part of the manufacturing equipment; and present the identified modification of the current operating conditions.

In some embodiments, the modification of the current operating conditions of the manufacturing equipment is identified based on physics-based simulation data.

In some embodiments, the processor is further configured to: calculate second adjusted equipment health status information associated with second manufacturing equipment that conducts the manufacturing process, wherein the second adjusted equipment health status information is based on the second manufacturing equipment having the at least one component of the manufacturing equipment; and presenting a recommendation to remove the at least one component from the manufacturing equipment to use in the second manufacturing equipment based on the second adjusted equipment health status information.

In some embodiments, the second adjusted equipment health status information is calculated in response to determining that the RUL of the at least one component is below a predetermined threshold These and other features of the disclosure will be described in more detail below with reference to the associated drawings.

In some embodiments, the recommendation is presented in response to determining that a second RUL corresponding to the at least one component when used in the second manufacturing equipment exceeds the RUL of the at least one component when used in the manufacturing equipment.

In accordance with some embodiments, a predictive maintenance system is provided, comprising: a memory; and a hardware processor that, when executing computer-executable instructions stored in the memory, is configured to: receive offline data that indicates historical operating conditions and historical manufacturing information corresponding to manufacturing equipment that conducts a manufacturing process, wherein the offline data comprises offline sensor data from a plurality of sensors associated with the manufacturing equipment; generate a plurality of physics-based simulation values using one or more physics-based simulation models that each model a component of the manufacturing equipment; train a neural network that generates a predicted equipment health status score using the offline data and the plurality of physics-based simulation values.

In some embodiments, each training sample used to train the neural network comprises the offline data and the plurality of physics-based simulation values as input values and metrology data as a target output.

In some embodiments, a physics-based simulation value of the plurality of physics-based simulation value is an estimation of a measurement corresponding to a sensor of the plurality of sensors.

In some embodiments, the sensor of the plurality of sensors is located at a first position of the manufacturing equipment, and wherein the estimation of the measurement is at a second position of the manufacturing equipment.

In some embodiments, the historical manufacturing information comprises Failure Mode and Effects Analysis (FMEA) information corresponding to the manufacturing equipment.

In some embodiments, the historical manufacturing information comprises design information related to the manufacturing equipment.

In some embodiments, the historical manufacturing information comprises quality information retrieved from a quality database.

### BRIEF DESCRIPTION OF THE DRAWINGS

FIG. 1A presents a block diagram of a predictive maintenance system in accordance with some embodiments of the disclosed subject matter.

FIG. 1B presents a block diagram of software modules used in a predictive maintenance system in accordance with some embodiments of the disclosed subject matter.

FIGS. 2A, 2B, 2C, and 2D present general examples of techniques to generate equipment health status information in accordance with some embodiments of the disclosed subject matter.

FIGS. 3A and 3B present flow diagrams of operations of a processor in accordance with some embodiments of the disclosed subject matter.

FIGS. 4A, 4B, 4C, and 4D present examples of techniques related to equipment health status information for an electrostatic chuck sub-system in accordance with some embodiments of the disclosed subject matter.

FIG. 5 presents an example computer system that may be employed to implement certain embodiments described herein.

### DETAILED DESCRIPTION

### Terminology

The following terms are used throughout the instant specification:

The terms “semiconductor wafer,” “wafer,” “substrate,” “wafer substrate” and “partially fabricated integrated circuit” may be used interchangeably. Those of ordinary skill in the art understand that the term “partially fabricated integrated circuit” can refer to a semiconductor wafer during any of many stages of integrated circuit fabrication thereon. A wafer or substrate used in the semiconductor device industry typically has a diameter of 200 mm, or 300 mm, or 450 mm. Besides semiconductor wafers, other work pieces that may take advantage of the disclosed embodiments include various articles such as printed circuit boards, magnetic recording media, magnetic recording sensors, mirrors, optical elements, micro-mechanical devices and the like. The work piece may be of various shapes, sizes, and materials.

A “semiconductor device fabrication operation” as used herein is an operation performed during fabrication of semiconductor devices. Typically, the overall fabrication process includes multiple semiconductor device fabrication operations, each performed in its own semiconductor fabrication tool such as a plasma reactor, an electroplating cell, a chemical mechanical planarization tool, a wet etch tool, and the like. Categories of semiconductor device fabrication operations include subtractive processes, such as etch processes and planarization processes, and material additive processes, such as deposition processes (e.g., physical vapor deposition, chemical vapor deposition, atomic layer deposition, electrochemical deposition, electroless deposition). In the context of etch processes, a substrate etch process includes processes that etch a mask layer or, more generally, processes that etch any layer of material previously deposited on and/or otherwise residing on a substrate surface. Such etch process may etch a stack of layers in the substrate.

“Manufacturing equipment” refers to equipment in which a manufacturing process takes place. Manufacturing equipment often has a processing chamber in which the workpiece resides during processing. Typically, when in use, manufacturing equipment perform one or more semiconductor device fabrication operations. Examples of manufacturing equipment for semiconductor device fabrication include deposition reactors such as electroplating cells, physical vapor deposition reactors, chemical vapor deposition reactors, and atomic layer deposition reactors, and subtractive process reactors such as dry etch reactors (e.g., chemical and/or physical etch reactors), wet etch reactors, and ashers.

An “anomaly” as used herein is a deviation from the proper functioning of a process, layer, or product. For example, an anomaly can include improper setpoints or operating conditions, such as improper temperatures, improper pressures, improper gas flow rates, etc.

In some embodiments, an anomaly can result in or cause a failure in a component of a system or sub-system of manufacturing equipment, such as a process chamber. For example, an anomaly can result in a failure in a component of an electrostatic chuck (ESC). As a more particular example, failures associated with an ESC can include failures in components of the ESC, such as a valve, a pedestal, an edge ring, etc. As a specific example, a failure can include a fracture in the pedestal. As another specific example, a failure can include a tear or break in an edge ring. Other systems or sub-systems of a process chamber for which anomalies can be detected can include a showerhead, an RF generator, a plasma source, etc. The anomalies may be random or systematic.

“Metrology data” as used herein refers to data produced, at least in part, by measuring features of a processed substrate or reaction chamber in which the substrate is processed. The measurement may be made while or after performing the semiconductor device manufacturing operation in a reaction chamber. In some embodiments, metrology data is produced by a metrology system performing microscopy (e.g., scanning electron microscopy (SEM), transmission electron microscopy (TEM), scanning transmission electron microscopy (STEM), reflection electron microscopy (REM), atomic force microscopy (AFM)) or optical metrology on the etched substrate. When using optical metrology, a metrology system may obtain information about defect location, shape, and/or size by calculating them from measured optical metrology signals. In some embodiments, the metrology data is produced by performing reflectometry, dome scatterometry, angle-resolved scatterometry, small-angle X-ray scatterometry and/or ellipsometry on a processed substrate. In some embodiments, the metrology data includes spectroscopy data from, e.g., energy dispersive X-ray spectroscopy (EDX). Other examples of metrology data include sensor data such as temperature, environmental conditions within the chamber, change in the mass of the substrate or reactor components, mechanical forces, and the like. In some embodiments, virtual metrology data can be generated based on sensor logs.

In some embodiments, the metrology data includes “metadata” pertaining to a metrology system or conditions used in obtaining the metrology data. Metadata may be viewed as a set of labels that describe and/or characterizes the data. A non-exclusive list of metadata attributes includes:
Process Tools design and operation information such as platform information, robot arm design, tool material details, part information, process recipe information, etc.
Image capture details such as contrast, magnification, blur, noise, brightness, etc.
Spectra generation details such as x-ray landing energy, wavelength, exposure/sampling time, chemical spectra, detector type, etc.
Metrology tool details such as defect size, location, class identification, acquisition time, rotation speed, laser wavelength, edge exclusion, bright field, dark field, oblique, normal incidence, recipe information, etc.
Sensor data from the fabrication process (which may be in-situ or ex-situ): spectral range of captured data, energy, power, process end point details, detection frequency, temperature, other environment conditions, etc.)

A “machine learning model” as used herein is a trained computational algorithm that has been trained to build a mathematical model of relationships between data points. A trained machine learning model can generate outputs based on learned relationships without being explicitly programmed to generate the output using explicitly defined relationships.

The techniques described herein can use machine learning models for many different purposes. For example, a trained machine learning model can be a feature extraction model that takes, as an input, a signal (e.g., a time series signal of sensor data, spectroscopy data, optical emissions data, etc.), and generates, as an output, one or more features that reduces the input signal by identifying key features or dimensions of the input signal. As a more particular example, a feature extraction model can be used to denoise a time series signal by identifying key features of the time series signal that are unlikely to be noise.

As another example, a trained machine learning model can be a classifier that takes, as an input, data indicating operating conditions of manufacturing equipment or a component of manufacturing equipment, and generates, as an output, a classification of the manufacturing equipment as operating under anomalous conditions. In some embodiments, anomalous conditions can include a failure in a particular component of a system or sub-system and/or a failure of a system or sub-system to achieve desired operating conditions (e.g., a desired temperature, a desired pressure, a desired gas flow rate, a desired power, etc.)

As yet another example, a trained machine learning model can be a neural network that takes, as inputs, data indicating operating conditions of manufacturing equipment or a component of manufacturing equipment and generates, as an output, predicted equipment health status information associated with the manufacturing equipment. Note that equipment health status information is described in more detail below.

Examples of machine learning models include autoencoder networks (e.g., a Long-Short Term Memory (LSTM) autoencoder, a convolutional autoencoder, a deep autoencoder, and/or any other suitable type of autoencoder network), neural networks (e.g., a convolutional neural network, a deep convolutional network, a recurrent neural network, and/or any other suitable type of neural network), clustering algorithms (e.g., nearest neighbor, K-means clustering, and/or any other suitable type of clustering algorithms), random forests models, including deep random forests, restricted Boltzmann machines, Deep Belief Networks (DBNs), recurrent tensor networks, and gradient boosted trees.

Note that, some machine learning models are characterized as “deep learning” models. Unless otherwise specified, any reference to “machine learning” herein includes deep learning embodiments. A deep learning model may be implemented in various forms, such as by a neural network (e.g., a convolutional neural network). In general, though not necessarily, it includes multiple layers. Each such layer includes multiple processing nodes, and the layers process in sequence, with nodes of layers closer to the model input layer processing before nodes of layers closer to the model output. In various embodiments, one layers feeds to the next, etc.

In various embodiments, a deep learning model can have significant depth. In some embodiments, the model has more than two (or more than three or more than four or more than five) layers of processing nodes that receive values from preceding layers (or as direct inputs) and that output values to succeeding layers (or the final output). Interior nodes are often “hidden” in the sense that their input and output values are not visible outside the model. In various embodiments, the operation of the hidden nodes is not monitored or recorded during operation.

The nodes and connections of a deep learning model can be trained and retrained without redesigning their number, arrangement, etc.

As indicated, in various implementations, the node layers may collectively form a neural network, although many deep learning models have other structures and formats. In some instances, deep learning models do not have a layered structure, in which case the above characterization of “deep” as having many layers is not relevant.

“Bayesian analysis” refers to a statistical paradigm that evaluates a prior probability using available evidence to determine a posterior probability. The prior probability is a probability distribution that reflects current knowledge or subjective choices about one or more parameters to be examined. The prior probability may also include a coefficient of variance or reporting limit of stored measurements. Evidence can be new data that is collected or sampled which affects the probability distribution of the prior probability. Using Bayes theorem or a variation thereof, the prior probability and evidence are combined to produce an updated probability distribution called the posterior probability. In some embodiments, Bayesian analysis can be repeated multiple times, using the posterior probability as a new prior probability with new evidence.

The term “manufacturing information” refers to information regarding a type of manufacturing equipment, such as a type of process chamber. In some embodiments, manufacturing information may include information about use of the manufacturing equipment, such as information indicating particular recipes that can be implemented on the manufacturing equipment. In some embodiments, manufacturing information can include manually-generated or expert-generated failure information, such as Failure Modes and Effects Analysis (FMEA) information. In some embodiments, any other design information can be integrated, such as information from quality databases, etc.

In some embodiments, “manufacturing information” can include information specific to a particular instance of manufacturing equipment, such as a particular process chamber. For example, manufacturing information can include historical maintenance information of a particular process chamber, such as particular dates components were previously replaced or serviced, particular dates failures previously occurred, and/or any other suitable historical maintenance information. As another example, manufacturing information can include upcoming maintenance information, such as dates of scheduled maintenance for particular systems or sub-systems of the instance of manufacturing equipment.

“Data-driven signals” refer to data measured or collected using any suitable sensor or instrument associated with a system or sub-system of manufacturing equipment. For example, data-driven signals can include temperature measurements, pressure measurements, spectroscopic measurements, optical emissions measurements, gas flow measurements, and/or any other suitable measurements. As a more particular example, in some embodiments, data-driven signals can include Continuous Trace Data (CTD) collected from one or more sensors. Note that data-driven signals can be either offline (e.g., collected previously at a prior point in time relative to a current time manufacturing equipment is being operated) or real-time (e.g., collected during operation of the manufacturing equipment).

“Physics-based simulation values” refer to values generated using a simulation, which is generally referred to herein as a “physics-based algorithm.” For example, in some embodiments, a physics-based simulation value can be an estimated value of a parameter (e.g., temperature, pressure, and/or any other suitable parameter) that is calculated based on a model of the parameter within a particular environment. As a more particular example, a physics-based simulation value can be a temperature estimate at a particular spatial location of an ESC that is calculated based on a model of temperature gradients of the ESC.

A physics-based algorithm can use any suitable technique(s) to model a particular component or physical phenomenon (e.g., temperature gradients in an environment that includes particular materials, gas flow within a chamber having particular dimensions, and/or any other suitable physical phenomena) using explicitly-defined physics laws or equations. For example, in some embodiments, a physics-based algorithm can use any suitable numerical modeling techniques that generates a simulation of a physical phenomena over a series of time steps or spatial steps.

“Predictive maintenance” refers to monitoring and predicting a health status of manufacturing equipment or components of manufacturing equipment based on characteristics of the manufacturing equipment and/or based on the components of the manufacturing equipment. In some embodiments, manufacturing equipment can include systems or sub-systems of a chamber, such as an ESC, a showerhead, a plasma source, a Radio Frequency (RF) generator, and/or any other suitable type of manufacturing system or sub-system). In some embodiments, components of manufacturing equipment can include individual components of a system and/or a subsystem, such as a pedestal, an edge ring of an ESC, a particular valve (e.g., of a gas box which supplies gases to a showerhead), and/or any other suitable component.

A predictive maintenance system as described herein can perform any suitable analysis that generates “equipment health status information.” “Equipment health status information” as used herein is an analysis of an operating condition of manufacturing equipment. In some embodiments, equipment health status information can include scores or metrics for an entire system or sub-system of manufacturing equipment (e.g., a showerhead, an ESC, a plasma source, an RF generator, and/or any other suitable system and/or sub-system). Additionally or alternatively, in some embodiments, equipment health status information can include scores or metrics for individual components of a system or sub-system, such as a pedestal of an ESC, an edge ring of an ESC, a particular valve (e.g., of a gas box which supplies gases to a showerhead), and/or any other suitable component.

In some embodiments, examples of equipment health status scores or metrics related to systems or sub-systems of manufacturing equipment can include a Mean Time to Failure (MTTF), a Mean Time to Maintenance (MTTM), a Mean Time Between Failures (MTBF), and/or any other suitable equipment health status information.

In some embodiments, examples of equipment health status scores or metrics for components of a system or sub-system can include a Remaining Useful Life (RUL) of the component. For example, in some embodiments, a predictive maintenance system can determine that the component will need to be replaced at a particular time in the future (e.g., in ten days, in twenty days, etc.).

In some embodiments, equipment health status information can include prescriptive maintenance recommendations identified by the predictive maintenance system. For example, in some embodiments, in response to identifying a particular RUL of a component that is less than a predetermined threshold time (e.g., less than ten days, less than twenty days, etc.), the predictive maintenance system can identify one or more actions that can be taken to increase the RUL of the component. As a more particular example, in some embodiments, the predictive maintenance system can identify a change to a recipe used by the manufacturing equipment (e.g., a temperature change, a pressure change, and/or any other suitable recipe change) that is likely to extend the RUL of the component. As another more particular example, in some embodiments, the predictive maintenance system can identify that a replacement of a different component is likely to extend the RUL of the component. As a specific example, the predictive maintenance system can recommend replacing a valve of an ESC to extend an RUL of an edge ring of the ESC.

In some embodiments, a predictive maintenance system can identify an imminent failure. For example, in some embodiments, the predictive maintenance system can detect an anomaly in a component of a system or sub-system of manufacturing equipment. In some embodiments, in response to detecting an anomaly, the predictive maintenance system can perform any suitable root cause analysis or other failure analysis to identify a cause of the anomaly. For example, in some embodiments, the predictive maintenance system can perform a failure analysis (e.g., a fishbone analysis, a five why analysis, a fault tree analysis, etc.) to identify likely causes of the anomaly.

Note that, in some embodiments, a predictive maintenance system as described herein can use any suitable techniques to predict a health status of equipment. For example, in some embodiments, the predictive maintenance system can use a machine learning model, such as a trained neural network, to generate equipment health status information.

As a more particular example, in some embodiments, the predictive maintenance system can generate a predicted equipment health status information that indicates a health status of the equipment based on previously measured characteristics of the equipment (referred to herein as offline information) assuming a typical rate of deterioration of the equipment (e.g., due to wear and tear). Continuing further with this particular example, in some embodiments, the predictive maintenance system can generate an estimated equipment health status information that indicates estimates of a current health status of the equipment based on real-time data (e.g., real-time data collected from sensors associated with the equipment, real-time spectroscopy information, real-time manufacturing conditions of the equipment, and/or any other suitable real-time data). Continuing still further with this particular example, in some embodiments, the predictive maintenance system can generate an adjusted equipment health status information that combines the predicted health status information based on offline data and the estimated health status information based on the real-time data. In some embodiments, the adjusted health status information can then be fed back as current health status information that can be used by the predictive maintenance system for subsequent equipment health status information calculations.

In some embodiments, prescriptive maintenance includes a failure analysis to determine what conditions or design features drove a component to fail or degrade. Such aspects of preventative maintenance may involve a post mortem analysis to identify a root cause of a component failure or degradation. The preventative maintenance may be used to help redesign a component.

Note that, in some embodiments, a machine learning model that generates equipment health status information can use any suitable inputs. For example, the inputs can include data-driven signals (e.g., data from one or more sensors associated with the manufacturing equipment), recipe information, historical failure information (e.g., FMEA information, a maintenance log that indicates previous maintenance actions on the manufacturing equipment, etc.), metrology data, physics-based signals (e.g., simulated values generated using a physics-based algorithm that models a particular system or sub-system), and/or any other suitable inputs.

### Overview

The predictive maintenance system described herein can be used for predictive maintenance of semiconductor fabrication equipment, such as wafer holders (e.g., ESCs), RF generators, plasma sources, showerheads, etc. For example, in some embodiments, the predictive maintenance system described herein can assess a current equipment health status of a system or a sub-system to indicate a likely time until failure or a likely time until the system or sub-system requires maintenance. As another example, in some embodiments, the predictive maintenance system described herein can assess individual components (e.g., individual edge rings, individual valves, etc.) and estimate a likely RUL of the individual components. In some embodiments, by predicting a time until failure or a time until maintenance will be required, the predictive maintenance system described herein can allow for significantly less downtime of manufacturing equipment due to unforeseen failures. Additionally, the predictive maintenance system described herein can allow for just-in-time part ordering that allows components identified as likely to fail soon to be replaced prior to failure.

In addition to generating predictive maintenance metrics, in some embodiments, the predictive maintenance system described herein can generate prescriptive maintenance recommendations. For example, the predictive maintenance system can identify that a particular component is likely to fail within a predetermined time period (e.g., within the next ten days), and can additionally identify a recommendation (e.g., a replacement of a different component, a change in a recipe implemented by the manufacturing equipment, etc.) that is likely to extend the life of the component. By proactively generating prescriptive maintenance recommendations, the predictive maintenance described herein can allow manufacturing equipment to be used for longer time periods between scheduled maintenance appointments, thereby increasing efficiency of the equipment.

In some embodiments, the predictive maintenance system described herein can identify anomalies, or imminent failures of manufacturing equipment. For example, an anomaly can be detected during a current fabrication process, such as a pedestal platen crack of an ESC, excessive power at an RF generator, unleveling of a showerhead, etc. In some embodiments, the predictive maintenance system described herein can identify a likely failure, as well as a likely cause of the failure. In some embodiments, by automating failure analysis, the predictive maintenance system described herein can reduce manual time required to analyze failures, thereby increasing efficiency.

In some embodiments, predictive maintenance metrics, prescriptive maintenance recommendations, and failure analysis can be generated using machine learning models. The machine learning models can be trained using both offline information that includes historical information from previous uses of an item of manufacturing equipment as well as real-time information that includes current data during a current use of the item of manufacturing equipment. By combining offline and real-time information, a predicted equipment health status based on known deterioration of the equipment can be adjusted based on current, real-time information to generate a more accurate real-time status of the manufacturing equipment.

In some embodiments, the machine learning models can include physics-based simulation values and/or data-driven signals. In some embodiments, physics-based simulation values can be a result of physics-based simulations of various physical phenomena. In some embodiments, the physics-based simulation values can be used to train models that generate equipment health status information, identify root causes of anomalies or failures, identify parameters that can be changed to extend an RUL of a particular component, and/or for any other suitable purpose. In some embodiments, data-driven signals can be measured data (e.g., sensor data, spectroscopy data, optical emissions data, etc.) that can be used by the machine learning models to indicate measured characteristics of a process chamber.

### Predictive Maintenance System

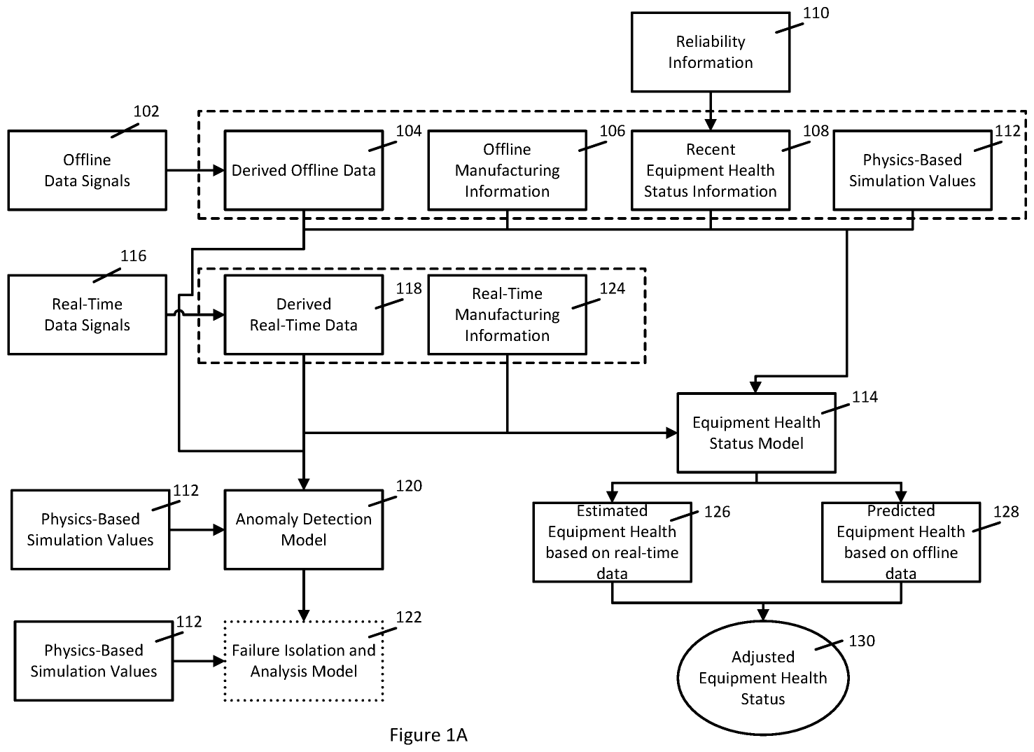

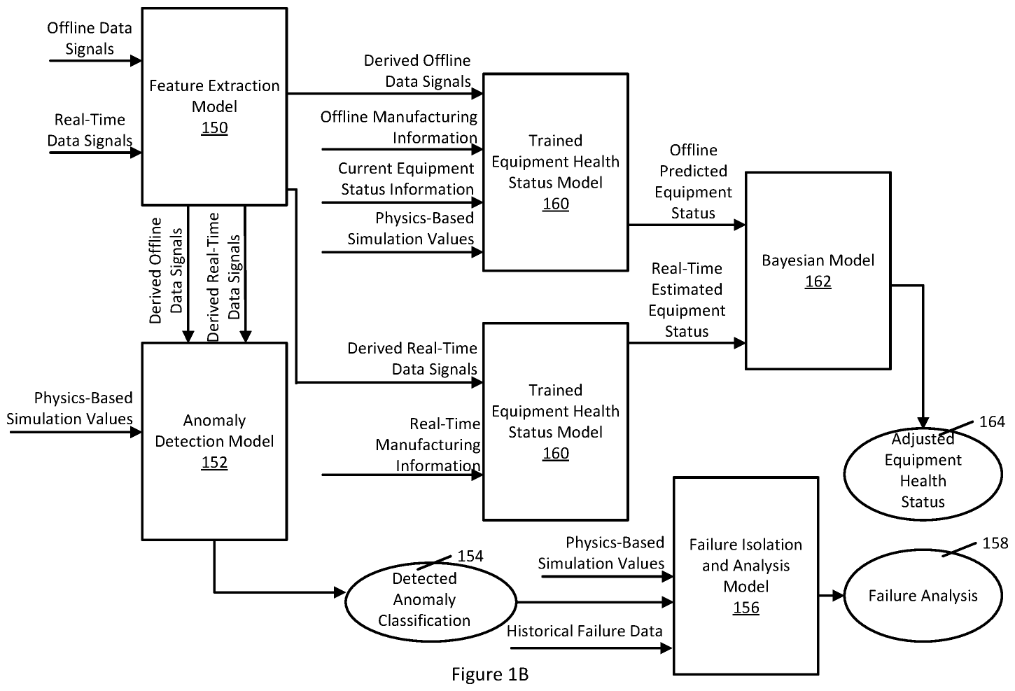

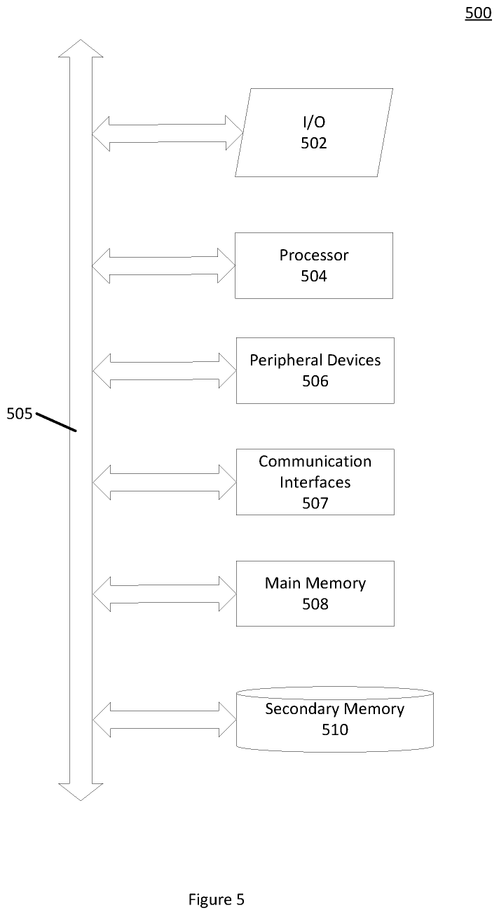

FIG. 1A shows a schematic diagram of a predictive maintenance system in accordance with some embodiments of the disclosed subject matter. In some embodiments, the predictive maintenance system can be operated with respect to a manufacturing equipment system or sub-system, such as an ESC, a showerhead, an RF generator, a plasma source, and/or any other suitable system or sub-system. Note that, in some embodiments, the predictive maintenance system can be implemented using a computational system that can perform any suitable functions (e.g., execute any suitable algorithms, receive data from any suitable sources, generate any suitable outputs, etc.). In some embodiments, the computational system can include any suitable devices (e.g., servers, desktop computer, laptop computers, etc.), each of which can include any suitable hardware, as shown in and described below in more detail in FIG. 5.

Note that more detailed techniques associated with blocks shown in FIG. 1A are described below in more detail in connection with FIG. 1B.

Offline data signals 102 can be received. In some embodiments, offline data signals 102 can include any suitable data collected during previous operation of the manufacturing equipment. As described above, offline data signals 102 can include data collected from any suitable sensors (e.g., temperature sensors, position sensors, pressure sensors, force sensors, gas flow sensors, and/or any other suitable type of sensors) associated with the manufacturing equipment, spectroscopy data, optical emissions data, and/or any other suitable measurements collected during previous operation of the manufacturing equipment. In some embodiments, offline data signals 102 can be a set of time series data sequences, such as a temperature data time series, a pressure data time series, etc. Note that offline data signals 102 may have been collected over any suitable time period, such as within the past month, within the past two months, etc.

Offline data signals 102 can be used to generate derived offline data 104. In some embodiments, derived offline data 104 can correspond to features that represent offline data signals 102. In some embodiments, derived offline data 104 can be generated using a feature extraction model, such as shown in and described below in connection with FIG. 1B. In some cases, offline data signals 102 are used without feature extraction or other derivation process. In such cases, the derived offline data 104 is offline data signals 102.

Offline manufacturing information 106 can be received.

In some embodiments, offline manufacturing information 106 can include recipe information. For example, in some embodiments, the recipe information can indicate one or more recipes typically implemented on the manufacturing equipment, where each recipe can indicate steps of a process, setpoints used in a process, and/or materials used in a process.

In some embodiments, the offline manufacturing information can include failure mode information. For example, in some embodiments, the failure mode information can include FMEA information that indicates potential failures associated with the manufacturing equipment and likely causes of each of the potential failures. As another example, in some embodiments, the failure mode information can include historical failures associated with the particular item of manufacturing equipment for which the machine learning model is being trained. As a more particular example, the historical failure information can indicate particular components that have previously failed, as well as dates each component failed and/or a reason for failure. As another more particular example, in some embodiments, the historical failure information can include dates particular components were previously replaced. In some embodiments, the failure mode information can include quality information indicating frequency of failure of different components, a typical maintenance schedule for particular components, and/or any other suitable quality information.

In some embodiments, the offline manufacturing information can include design information about the type of manufacturing equipment. In some embodiments, design information can include specifications for particular components of the manufacturing equipment.

In some embodiments, the offline manufacturing information can include maintenance log information for the particular item of manufacturing equipment for which the machine learning model is being trained. For example, the maintenance log can indicate dates particular components of the manufacturing equipment were replaced. As another example, the maintenance log can indicate expected lifetimes of particular components. As yet another example, the maintenance log can indicate dates particular systems or sub-systems were previously serviced. As still another example, the maintenance log can indicate a next future service date for a particular system or sub-system.

Recent equipment health status information 108 can be received or calculated. In some embodiments, recent equipment health status information 108 can include any suitable metrics that include recently calculated equipment health status information, such as from a previous inference of the predictive maintenance system. As described above, recent equipment health status information 108 can include scores or metrics indicating a health status of an entire system or sub-system, such as a MTTF, MTTM, MTBF, and/or any other suitable system or sub-system metric(s). Additionally, in some embodiments, recent equipment health status information 108 can include information indicating health statuses of any suitable individual components of a system or sub-system, such as RUL of individual components.

In some embodiments, recent equipment health status information 108 can be calculated using reliability information 110. In some embodiments, reliability information 110 can include performance information, such as metrology data, that indicates a recent performance of the manufacturing equipment. In some embodiments, the metrology data can include indications of defects in manufactured wafers, and/or any other suitable indications of performance problems. In some embodiments, recent equipment health status information 108 can be calculated from reliability information 110 using any suitable trained machine learning model, such as a neural network (e.g., a convolutional neural network, a deep convolutional neural network, a recurrent neural network, and/or any other suitable type of neural network). In some embodiments, the machine learning model can be trained using training samples that include metrology data as inputs and a manually annotated performance indicator (e.g., that indicates whether or not a failure or anomaly is associated with the metrology data).

Physics-based simulation values 112 can be generated. In some embodiments, physics-based simulation values 112 can be any suitable values generated using a physics-based algorithm. For example, physics-based simulation values 112 can include simulated temperature values, simulated pressure values, simulated force values, simulated spectroscopy values, and/or any other suitable simulated values.

In some embodiments, a physics-based value can be a simulated value that corresponds to a measured parameter. For example, in an instance in which a thermocouple measures a temperature at a particular location, a physics-based algorithm can generate a physics-based simulation value that estimates the temperature at a location some distance (e.g., 5 cm, 10 cm, etc.) from the thermocouple. As another example, in an instance in which a pressure sensor measures a pressure at a particular location, a physics-based algorithm can generate a physics based simulation value that estimates the pressure at a location some distance (e.g., 5 cm, 10 cm, etc.) from the pressure sensor. Note that, in some embodiments, a physics-based algorithm can generate simulated values that represent data from virtual sensors. In some embodiments, physics-based simulation values can be values interpolated from physical measurements, such as physical measurements spanning a mesh. Additionally or alternatively, in some embodiments, physics-based simulation values can be values calculated using a regression from physical measurements.

An equipment health status machine learning model 114 can be trained using derived offline data 104, offline manufacturing information 106, recent equipment health status information 108, and physics-based simulation values 112.

Note that, once trained, equipment health status machine learning model 114 can be used to generate estimated equipment health status information and/or predicted equipment health status information, as described below in more detail.

Real-time data signals 116 can be received. In some embodiments, real-time data signals 116 can include data collected from any suitable sensors (e.g., temperature sensors, position sensors, pressure sensors, force sensors, gas flow sensors, and/or any other suitable type of sensors) associated with the manufacturing equipment, spectroscopy data, optical emissions data, and/or any other suitable measurements collected during current operation of the manufacturing equipment. In some embodiments, real-time data signals 116 can be a set of time series data sequences, such as a temperature data time series, a pressure data time series, etc.

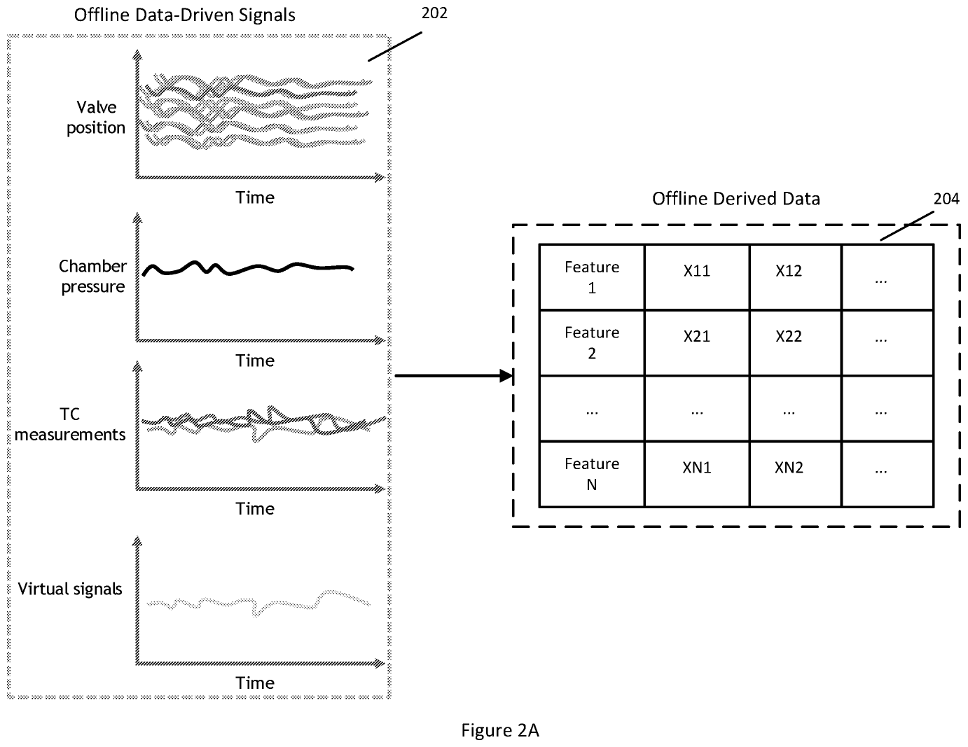

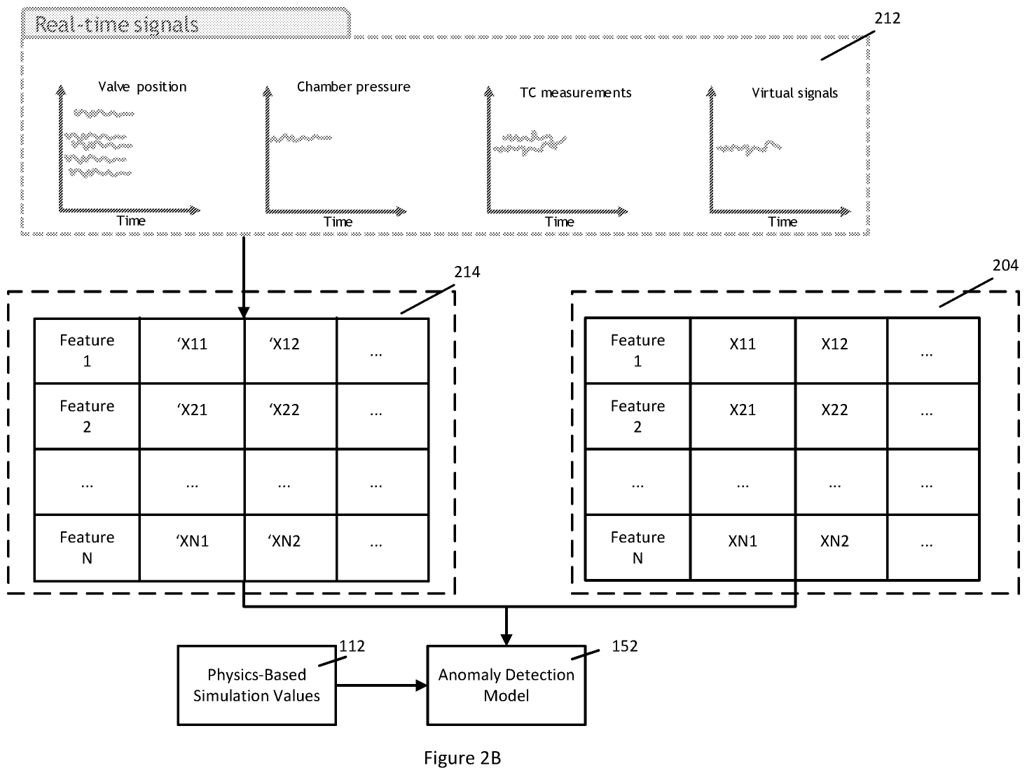

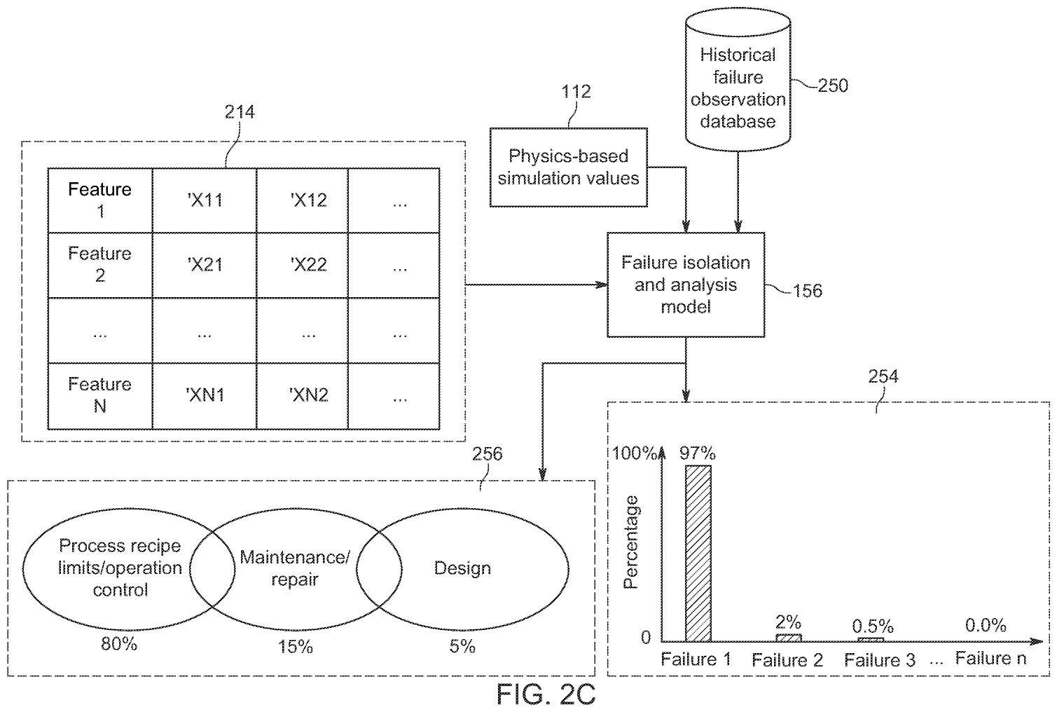

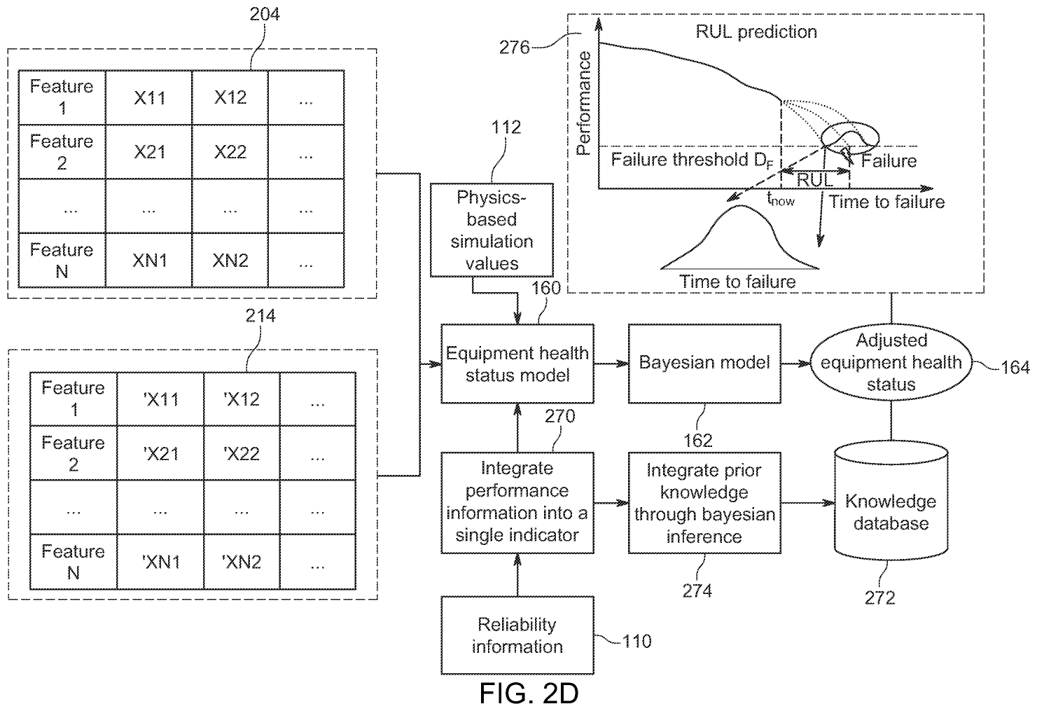

Derived real-time data 118 can be generated using real-time data signals 116. For example, in some embodiments, derived real-time data 118 can be generated using a feature extraction model applied to real-time data signals 116, such as shown in and described below in connection with FIG. 2A. In some cases, real-time data signals 116 are used without feature extraction or other derivation process. In such cases, the derived real-time data 118 is real-time data signals 116.

An anomaly detection model 120 can detect an imminent failure of the manufacturing equipment by detecting an anomalous condition in a current state of the manufacturing equipment. In some embodiments, anomaly detection model 120 can take, as inputs, physics-based simulation values 112, derived offline data 104, and derived real-time data 118, as shown in FIG. 1A and as described below in more detail in connection with FIG. 2B.

In some embodiments, if an anomaly is detected by anomaly detection model 120, a failure isolation and analysis model 122 can perform an analysis of the detected anomaly. In some embodiments, failure isolation and analysis model 122 can identify a particular failure in a system or sub-system, such as chipping or cracking in a pedestal of an ESC, flaking associated with a showerhead, excessive power or no power associated with an RF generator, etc. Moreover, in some embodiments, failure isolation and analysis model 122 can identify a root cause of an identified failure. In some embodiments, failure isolation and analysis model 122 can take, as inputs, derived real-time data 118 and physics-based simulation values 112, as shown in FIG. 1A and as described below in more detail in connection with FIG. 2C.

Real-time manufacturing information 124 can be received. In some embodiments, real-time manufacturing information 124 can indicate current process information, such as a recipe currently being implemented by the manufacturing equipment.

An estimated equipment health status information 126 can be generated using derived real-time data 118 and real-time manufacturing information 124 as inputs to trained equipment health status machine learning model 114. In some embodiments, estimated equipment health status information 126 can indicate an estimated current health status of the manufacturing equipment based on the current process being implemented and the real-time data being collected during execution of the process.

A predicted equipment health status information 128 can be generated using derived offline data 104, offline manufacturing information 106, recent equipment health status information 108, and/or physics-based simulation values 112 as inputs to trained equipment health status machine learning model 114. In some embodiments, predicted equipment health status information 128 can indicate a predicted health status of the manufacturing equipment at a current time due to typical deterioration of the manufacturing equipment and/or components of the manufacturing equipment.

Adjusted equipment health status information 130 can be generated by combining estimated equipment health status information 126 (e.g., the equipment health status information based on the real-time data) and predicted equipment health status information 128 (e.g., the equipment health status information based on the offline data). For example, in some embodiments, adjusted health status information 130 can be generated using any suitable techniques, such as Bayesian inference to combine estimated equipment health status information 126 and predicted equipment health status information 128. As a more particular example, adjusted equipment health status scores or metrics can be calculated by using Bayesian inference to combine one or more equipment health status scores or metrics associated with estimated equipment health status information 126 with corresponding scores or metrics associated with predicted equipment health status information 128.

Note that, with respect to the estimated equipment health status information, the predicted equipment health status information, and the adjusted equipment health status information described above, equipment health status information can include any suitable information or metrics. For example, equipment health status information can include scores or metrics related to a system or sub-system, such as an ESC, a plasma source, a showerhead, an RF generator, and/or any other suitable system or sub-systems. System or sub-system scores or metrics can include a MTTF, a MTTM, a MTBF, and/or any other suitable metrics.

As another example, in some embodiments, equipment health status information can include scores or metrics related to individual components of a system or sub-system, such as an edge ring of an ESC, a particular valve (e.g., of a gas box which supplies gases to a showerhead), and/or any other suitable component(s). Component scores or metrics can include an RUL of a component that indicates a predicted likely remaining time for use of the component prior to failure of the component.

As yet another example, in some embodiments, equipment health status information can include prescriptive maintenance recommendations. As a more particular example, in an instance in which an RUL of a particular component is less than a predetermined threshold (e.g., less than ten days, less than twenty days, etc.) and/or in which an RUL ends prior to scheduled replacement of the component, prescriptive maintenance recommendations can be generated. Continuing with this particular example, in some embodiments, the prescriptive maintenance recommendations can include a recommendation to replace a different component, where replacement of the different component is likely to extend the RUL of the component identified as likely to fail.

In some embodiments, the prescriptive maintenance recommendations can additionally or alternatively include recommendations to change recipe parameters. For example, in some embodiments, changes to a gas flow rate, a temperature change time window, and/or any other suitable recipe parameters can be identified, such that the change in recipe parameters is likely to extend the RUL of the component identified as likely to fail. In some embodiments, the prescriptive maintenance recommendations can include a recommendation to discontinue use of a particular recipe by the manufacturing equipment until the component identified as likely to fail has been replaced.

Note that, in instances in which prescriptive maintenance recommendations are identified, in some embodiments, one or more recommendations can be automatically implemented. For example, in an instance in which a change to a recipe parameter is identified (e.g., that a different gas flow rate is to be used, that a different temperature setting is to be used, etc.), the change can be automatically implemented without user input. Alternatively, in some embodiments, any suitable alert or notification can be presented (e.g., to a user tasked with maintenance of the equipment) that indicates the prescriptive maintenance recommendations.

Turning to FIG. 1B, an example of a block diagram that shows inputs and outputs of different models used in the predictive maintenance system described herein is shown in accordance with some embodiments of the disclosed subject matter.

Note that, in some embodiments, a feature extraction model 150, an anomaly detection classifier 152, a failure isolation and analysis model 156, a trained equipment health status information neural network 160, and/or a Bayesian model 162 can each be a machine learning model that is trained using any suitable training set. Each machine learning model can be of any suitable type and can have any suitable architecture.

Feature extraction model 150 can be used to extract features of data signals. In some embodiments, the data signals can include any suitable type of measured data, such as sensor data (e.g., temperature data, pressure data, force data, positional data, and/or any other suitable sensor data), spectroscopy data, optical emissions data, and/or any other suitable data. Feature extraction model 150 can then extract features of the data signals to generate derived data signals. For example, feature extraction model 150, once trained, can take offline data signals as an input and can generate derived offline data signals as an output. As another example, feature extraction model 150, once trained, can take real-time data signals as an input and can generate derived real-time data signals as an output.

In some embodiments, feature extraction model 150 can be any suitable type of machine learning model, such as an LSTM autoencoder, a deep convolutional neural network, a regression model, etc. In some embodiments, feature extraction model 150 can use Principal Components Analysis (PCA), Minimum Mean-Square Error (MMSE) filtering, and/or any other suitable techniques for dimension reduction prior to feature extraction.

Note that, in some embodiments, feature extraction model 150 can be omitted, for example, in cases where data signals are not denoised prior to use by other models. This may be appropriate when the available processing power can easily accommodate relatively simple or sparse input data.

Turning to FIG. 2A, an example schematic diagram for generating derived offline data from offline data signals is shown in accordance with some embodiments of the disclosed subject matter. As illustrated in FIG. 2A, a set of offline data signals 202 can be converted to a set of offline derived data 204, where derived data 204 includes N features, each with a value that represents a magnitude of the feature at different time points. For example, set of data-driven signals 202 can converted to a set of N features, with values of: {X₁₁, X₁₂, X_{1T}; X₂₁, X₂₂, . . . X_{2T}; X_{N1}, X_{N2}, . . . X_{NT}}, where Xᵢⱼ is the value of the i^{th} feature at time j. Note that, in some embodiments, derived offline data 204 can effectively represent offline data signals 202 with any noise removed by identifying salient features of data-driven signals 202 that are not likely to be noise.

Note that, although FIG. 2A is described above in connection with offline data signals, the techniques described above can be applied for feature extraction of real-time data signals, as well.

Referring back to FIG. 1B, anomaly detection classifier 152 can take, as inputs, derived offline data signals, derived real-time signals, and physics-based simulation values, and can determine whether the derived real-time signals represent an anomalous condition. In some embodiments, anomaly detection classifier 152 can generate a detected anomaly classification 154 that corresponds to a likelihood that the derived real-time data signals represent an anomaly.

In some embodiments, anomaly detection model 152 can be any suitable type of model that classifies derived data as anomalous or not anomalous. For example, in some embodiments, anomaly detection model 216 can be a clustering algorithm (e.g., a nearest neighbor algorithm, a K means algorithm, and/or any other suitable clustering algorithm), an LSTM autoencoder, a deep convolutional neural network, an RBM, a DBN, and/or any other suitable type of model.

Turning to FIG. 2B, an example schematic diagram for detecting anomalies is shown in accordance with some embodiments of the disclosed subject matter. As illustrated, real-time data signals 212 can be transformed to derived real-time data 214, using, for example, the techniques described above in connection with FIG. 2A.

In some embodiments, derived offline data 204 (e.g., as shown in and described above in connection with FIG. 2A) and derived real-time data 214 can be used as inputs to an anomaly detection model 152 that generates an output that classifies derived real-time data 214 as anomalous or not anomalous.

In some embodiments, anomaly detection model 152 can effectively determine if derived real-time data 214 represents an anomalous condition by comparing derived real-time data 214 to derived offline data 204. For example, certain derived offline data 204 can be treated as “golden values” to which derived real-time data 214 are compared to detect an anomaly in derived real-time data 214.

Referring back to FIG. 1B, if detected anomaly classification 154 indicates an anomaly in the derived real-time data signals, failure isolation and analysis model 156 can generate a failure analysis 158. In some embodiments, failure isolation and analysis model 158 can indicate a likely failure associated with the detected anomaly. Additionally, in some embodiments, failure isolation and analysis model 158 can indicate a likely cause for one or more identified failures.

Failure isolation and analysis model 156 can be any suitable type of machine learning model, such as a deep convolutional neural network, a clustering algorithm (e.g., a nearest neighbor algorithm, a K means algorithm, and/or any other suitable type of clustering algorithm), and/or any other suitable type of machine learning model.

Turning to FIG. 2C, a schematic diagram of failure analysis for a detected anomalous condition is shown in accordance with some embodiments of the disclosed subject matter.

As illustrated, failure isolation and analysis model 156 can take, as inputs, real-time derived data 214, information from historical failure observation database 250, and physics-based simulation values 112, and can generate, as outputs: 1) a distribution of likelihoods of different failures 254; and 2) likelihoods of causes for failure 256.

In some embodiments, physics-based simulation values 112 can be used by failure isolation and analysis model 156 in any suitable manner. For example, physics-based simulation values can be used to identify or define failure modes for a particular system or sub-system. As a more particular example, physics-based simulation values can identify that particular components (e.g., a pedestal of an ESC, an edge ring of an ESC, etc.) may crack or fracture under particular physical conditions, such as high temperature gradients, a high gas flow rate, high pressures, etc. As a specific example, in some embodiments, a physics-based simulation can be run to accelerate failures by simulating excessive values of parameters that may lead to failures. Continuing with this specific example, a physics-based simulation can be run with a temperature that is increased relative to a normal operating temperature, thereby allowing identification of particular components that are likely to fail (e.g., that a pedestal is likely to crack or chip, that a valve is likely to fail, etc.). Continuing still further with this specific example, in some embodiments, the physics-based simulation can then be used to identify parameters (e.g., a temperature ramp rate, a heater ratio, etc.) that can alter a time to failure of identified components.

In some embodiments, historical failure observation database 250 can include any suitable information. For example, in some embodiments, historical failure observation database 250 can include measurements collected at timepoints near previous failures of the manufacturing equipment (e.g., temperature data, pressure data, spectroscopy data, optical emissions data, gas flow data, and/or any other suitable type of measurements). As another example, in some embodiments, historical failure observation database 250 can include information that indicates causes of failure of a particular component. As a more particular example, in some embodiments, historical failure observation database 250 can indicate that cracks in a particular component were caused by particular temperature conditions (e.g., a large change in temperatures, etc.) a particular number of times or a particular percentage of times. Note that, in some embodiments, information that indicates causes of failure of particular components can be expert-sourced.

In some embodiments, distribution of likelihoods of different failures 254 can include any suitable number of potential failures associated with derived real-time data 214. As illustrated in FIG. 2C, each potential failure can be associated with a likelihood, assigned by failure isolation and analysis model 156, that the potential failure is applicable to derived real-time data 214.

In some embodiments, likelihoods of causes for failure 256 can include any suitable number of causes for failure in connection with a likelihood of each cause, each identified and assigned by failure isolation and analysis model 156. Note that, in some embodiments, causes for failure can be identified for a subset of the potential failures identified. For example, causes for failure can be identified for the top N most likely of the potential failures. As a more particular example, in an instance in which the most likely failure associated with real-time derived data 214 is a crack in an edge ring, likelihoods of causes for failure 256 can identify a set of likely causes for the crack in the edge ring, such as causes associated with a process or recipe implemented by the manufacturing equipment that would impact the edge ring, causes associated with maintenance and/or repair of the edge ring, and/or causes associated with design of the edge ring.

Referring back to FIG. 1B, trained equipment health status information model 160 can generate equipment health status information. For example, trained equipment health status information model 160 can generate offline predicted equipment health status information based on offline data (e.g., offline predicted equipment health status scores or metrics, such as MTTF, MTBF, and/or MTTM for particular systems or sub-systems, RULs of particular components, etc.), using the derived offline data signals, offline manufacturing information, current equipment health status information, and physics-based simulation values as inputs.

In some embodiments, equipment health status model 160 can be any suitable type of machine learning model, such as a deep convolutional network, a support vector machine (SVM), a random forest, a decision tree, a deep LSTM, a convolutional LSTM, and/or any other suitable type of machine learning model.

In some embodiments, equipment health status model 160 can be trained in any suitable manner. For example, in some embodiments, training samples can be constructed such that inputs corresponds to derived offline data, offline manufacturing information, and/or physics-based simulation values, and a target output for each training sample is a corresponding value of recent equipment health status information, which can be based on metrology data. Note that, in some embodiments, physics-based simulation values can additionally be included in target outputs of training samples.

Trained equipment health status information model 160 can additionally generate real-time estimated equipment health status information based on real-time data, using the derived real-time data signals and real-time manufacturing information as inputs.

Note that, in some embodiments, trained equipment health status information model 160 can additionally use physics-based simulation data as an input. For example, in an instance in which a physics-based simulation can be run in real-time, a physics-based simulation value can be generated to calculate the real-time estimated equipment health status information. Alternatively, in some embodiments, a machine learning model can be trained to predict physics-based simulation values. In some such embodiments, the trained machine learning model can be used to approximate physics-based simulation values, which can then be used to generate the real-time estimated equipment health status information.

Bayesian model 162 can generate adjusted equipment health status information 164 by combining the offline predicted equipment health status information and the real-time estimated equipment health status information. For example, in some embodiments, Bayesian model 162 can calculate a weighted average of offline predicted equipment health status scores or metrics and corresponding real-time estimated equipment health status scores or metrics, such as MTTF, MTBF, and/or MTTM of particular systems or sub-systems, RULs of particular components, etc. As a more particular example, each of the offline predicted equipment health status scores or metrics and the real-time estimated equipment health status scores or metrics can be associated with a weight used in the weighted average, where the weight can be updated using Bayesian inference. As another example, in some embodiments, Bayesian model 162 can use an ensemble learning method, such as stacking, boosting, and/or bagging. As yet another example, in some embodiments, Bayesian model 162 can mix offline predicted equipment heath status information and the real-time estimated equipment health status information and can then be retrained based on the mixed results.

Turning to FIG. 2D, a schematic diagram for calculating adjusted equipment health status information is shown in accordance with some embodiments of the disclosed subject matter.

In some embodiments, reliability information 110 (e.g., metrology data, particle data, and/or any other suitable data) can be combined with prior knowledge from a prior knowledge database 272. For example, in some embodiments, prior knowledge can be integrated through Bayesian inference 274. In some embodiments, the integrated prior knowledge can then be combined with reliability information to generate a performance indicator 270. In some embodiments, performance indicator 270 can encapsulate any suitable performance information, such as a predicted current reliability of systems, sub-systems, and/or individual components of the manufacturing equipment based on recent reliability information.

As described above, in some embodiments, equipment health status model 160 can generate predicted equipment health status information based on derived offline data 204 and estimated equipment health status information based on derived real-time data 214. In some embodiments, equipment health status model can use performance indicator 270 to generate the predicted equipment health status information and/or the estimated equipment health status information.

Additionally, in some embodiments, equipment health status model 160 can use physics-based simulation values 112 in any suitable manner. For example, in some embodiments, equipment health status model 160 can use physics-based simulation values 112 to simulate values associated with different physical parameters, such as a simulated temperature value at a particular location, a simulated pressure value at a particular location, etc.

In some embodiments, Bayesian model 162 can generate adjusted equipment health status information 164 by combining the predicted equipment health status information and the estimated equipment health status information using Bayesian inference.

As described above in connection with FIG. 1A, adjusted equipment health status information 164 can include any suitable scores or metrics, such as RUL prediction 276 that predicts an expected RUL for an individual component (e.g., a pedestal, an edge ring, a valve, etc.). Additionally, as described above in connection with FIG. 1A, the adjusted equipment health status information 164 can include MTTF, MTTM, and/or MTBF metrics for the system or sub-system. In some embodiments, RUL predictions for individual components and system or sub-system level metrics can be outputs of the trained equipment health status information model 160. For example, trained equipment health status model 160 can generate, as an output, system or sub-system level metrics as well as a list of components and a calculated expected RUL for each component.

In some embodiments, an RUL can be generated using physics-based simulation values. For example, in some embodiments, physics-based simulation values can be used to predict a state of a particular component over time under particular physical conditions. As a more particular example, an RUL for a particular component (e.g., a pedestal of an ESC, an edge ring of an ESC, etc.) can be predicted based at least in part on simulating values of parameters such as temperature, force, pressure, etc. under particular physical conditions. Specific examples can include temperatures at particular locations of a chamber, gas concentrations at particular locations of a chamber, pressures at particular locations of a chamber, etc.

Additionally, as described above in connection with FIG. 1A, trained equipment health status information model 160 can generate one or more prescriptive maintenance recommendations. For example, in response to identifying that a particular component has an RUL less than a predetermined threshold (e.g., less than ten days, less than twenty days, etc.) and/or that the RUL ends prior to a next scheduled maintenance data, trained equipment health status information model 160 can use knowledge database 272 to identify one or more prescriptive maintenance recommendations.

For example, in an instance in which an RUL for Component A is less than a predetermined threshold, trained equipment health status information model 160 can identify, using knowledge database 272, one or more recipe parameter changes that are likely to extend the RUL Component A. Note that, in some embodiments, information in knowledge database 272 can be expert-sourced, and can be keyed based on component. For example, knowledge database 272 may indicate, based on expert-sourced knowledge, that the RUL for Component A can be extended by changing particular recipe parameters, such as a gas flow rate, a temperature gradient, and/or any other suitable recipe parameters.

As another example, trained equipment health status information model 160 can identify, using knowledge database 272, one or more components that have an effect on Component A that can be replaced to extend an RUL of Component A. For example, knowledge database 272 can be queried to identify a group of components that have been identified (e.g., expert-sourced, and/or identified in any other suitable manner) as effecting Component A.

A yet another example, trained equipment health status information model 160 can identify, using knowledge database 272, that a particular recipe should not be implemented on the manufacturing equipment until Component A has been replaced, but that other recipes may be implemented on the manufacturing equipment. For example, knowledge database 272 can be include indications of an importance of Component A to different recipes implemented on the manufacturing equipment, and recipes that rely heavily on Component A can be identified as recipes that should not be implemented until replacement of Component A.

In some embodiments, physics-based simulation values can be used to identify prescriptive maintenance recommendations. For example, in some embodiments, physics-based simulation values can be used to identify parameters that may have an effect on a component identified as likely to fail. As a more particular example, in some embodiments, physics-based simulation values can be used to determine whether changing particular parameters (e.g., temperature, gas flow rates, etc.) are likely to have an effect on the identified component(s). In some embodiments, parameters identified using physics-based simulation values can be verified using expert-sourced information included in knowledge database 272. Additionally, in some embodiments, knowledge database 272 can be populated using simulation values output from physics-based simulations.

Note that, in some embodiments, a prescriptive maintenance recommendation can be fed back into trained equipment health status model 160 to determine a likelihood that the identified recommendation will extend the RUL of a particular component given the current real-time data. That is, in some embodiments, trained equipment health status model 160 can be used to verify an identified prescriptive maintenance recommendation (e.g., that has been identified using knowledge database 272) prior to providing or implementing the recommendation.

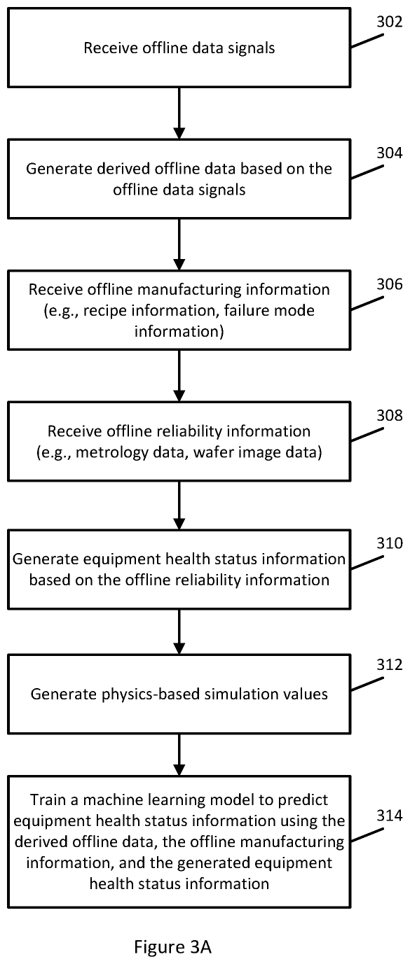

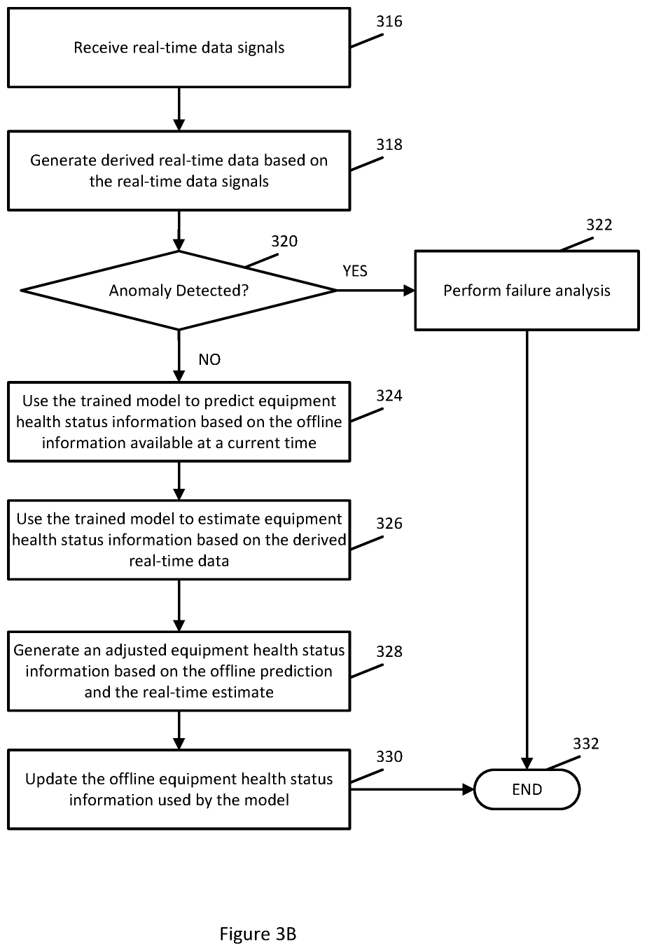

Turning to FIG. 3A, an example of a process for training a machine learning model to generate equipment health status information for manufacturing equipment is shown in accordance with some embodiments of the disclosed subject matter. Note that, in some embodiments, the process shown in FIG. 3A can be executed on any suitable device, such as a device (e.g., a server, a desktop computer, a laptop computer, and/or any other suitable device) that receives or retrieves data from sensors, databases, etc.

At 302, offline data signals can be received. As described above in connection with FIG. 1A, the offline time series data can be data from sensors associated with a system or sub-system (e.g., from an ESC, from a showerhead, from a plasma source, from an RF generator, and/or from any other suitable system or sub-system), spectroscopy data, optical emissions data, and/or any other suitable data measured during previous operation of the manufacturing equipment.

At 304, derived offline data can be generated based on the offline time series data. As described above in connection with FIGS. 1A and 2A, the derived offline data can include a representation of salient features of the offline data signals. In some embodiments, the derived data can be a denoised version of the offline data signals.

At 306, offline manufacturing information can be received. In some embodiments, the offline manufacturing information can include recipe information, failure mode information, and/or maintenance log information associated with the manufacturing information. Note that, in some embodiments, the failure mode information can be general information for the manufacturing equipment and/or specific to the particular item of manufacturing equipment for which the machine learning model is being trained.

At 308, offline reliability information can be received. As discussed above in connection with FIG. 1A, the offline reliability information can include metrology data collected from previous uses of the manufacturing equipment. As a more particular example, in some embodiments, the metrology data can include wafer image data captured of previously fabricated wafers. In some embodiments, offline reliability information can indicate a presence of defects in previously fabricated wafers.

At 310, equipment health status information can be generated based on the offline reliability information. In some embodiments, the equipment health status information can include any suitable scores or metrics, such as a metric that indicates a health status of a system or sub-system. For example, the equipment health status information can include a MTTF, a MTBF, a MTTM, and/or any other suitable metric. In some embodiments, the equipment health status information can include any suitable scores or metrics associated with individual components. For example, the equipment health status information can include RULs of individual components.

At 312, physics-based simulation values can be generated. As described above in connection with FIG. 1A, the physics-based simulation values can be simulated values of any suitable physical parameters (e.g., temperature, force, position, pressure, spectroscopy values, and/or any other suitable physical parameters). In some embodiments, the physics-based simulation values can be generated using any suitable physics-based algorithms. In some embodiments, the physics-based simulation values can be generated using an algorithm that takes any offline data values as input values, for example, to generate a corresponding simulated value that is simulated at a different time or different spatial position than a measured offline data value.

At 314, a machine learning model to predict equipment health status information can be trained using the derived offline data, the offline manufacturing information, the generated equipment health status information, and/or physics-based simulation values. In some embodiments, the machine learning model can be trained using any suitable training set. For example, in some embodiments, the training set can include example inputs that include the derived offline data, the offline manufacturing information, and/or the physics-based simulation values. Continuing with this example, in some embodiments, each training sample in the training set can include a target output that includes a corresponding equipment health status information generated at 310. In some embodiments, a target output can be based on physics-based simulation values.

Turning to FIG. 3B, an example of a process for using the trained machine learning model (e.g., from FIG. 3A) to identify and analyze an imminent failure of the manufacturing equipment and/or to generate current equipment health status information is shown in accordance with some embodiments of the disclosed subject matter.

At 316, real-time time data signals can be received. In some embodiments, as described above in connection with FIG. 1A, the real-time data signals can be data measured during current operation of the manufacturing equipment. The real-time data signals can include any suitable measured data, such as sensor data (e.g., temperature, pressure, force, position, and/or any other suitable sensor measurements), spectroscopy, optical emissions, and/or any other suitable real-time data.

At 318, derived real-time data can be generated based on the real-time data signals. Similar to what is described above with respect to the derived offline data described above in connection with block 304 of FIG. 1A, the derived real-time data can indicate salient features of the real-time data signals. In some embodiments, the derived real-time data can represent denoised versions of the real-time data signals.

At 320, a determination of whether an anomaly is detected can be made. In some embodiments, a detected anomaly can indicate an imminent failure of the manufacturing equipment, identified based on the derived real-time data. In some embodiments, an anomaly can be detected using an anomaly detection classifier that takes, as inputs, the derived real-time data and the derived offline data, as shown in and described above in connection with FIG. 1B.

If, at 320, an anomaly is detected (“yes” at 320), a failure analysis can be performed at 322. In some embodiments, the failure analysis can be performed using a failure isolation and analysis model, as shown in and described above in connection with FIG. 1B.

In some embodiments, the failure analysis can indicate a likely failure associated with the detected anomaly. For example, the failure analysis can indicate that a particular component is likely to have failed, thereby causing the detected anomaly. Additionally, in some embodiments, the failure analysis can determine a likely cause of the identified failure. For example, in an instance in which the failure analysis identified a particular component as having failed, the failure analysis can additionally indicate a likely cause for the failure of the particular component.

In some embodiments, the failure analysis can be conducted based on the derived real-time data, physics-based simulation values, information retrieved from a failure database, and/or any other suitable information, as described above in connection with FIG. 2C.

After performing the failure analysis, the process can end at 332.

Conversely, if, at 320, an anomaly is not detected (“no” at 320), predicted equipment health status information can be calculated at 324 by using offline data as an input to the trained machine learning model. In particular, in some embodiments, the inputs can include derived offline data, offline manufacturing information, and/or physics-based simulation values. Note that, in some embodiments, the predicted equipment health status information that is calculated using offline data can represent a predicted equipment health status information at the current time based on previously measured data, assuming typical deterioration of the equipment.

At 326, estimated equipment health status information can be calculated by using the real-time data as an input to the trained machine learning model. In particular, in some embodiments, the inputs can include the derived real-time data. Additionally, in some embodiments, the inputs can include any suitable real-time manufacturing information, such as a current recipe that is being implemented on the manufacturing information.

At 328, adjusted equipment health status information can be calculated by combining the predicted equipment health status information based on offline information and the estimated equipment health status information based on real-time information. In some embodiments, predicted equipment health status information and the estimated equipment health status information can be combined using any suitable technique(s), such as using Bayesian inference, as shown in and described above in connection with FIG. 1B. For example, in some embodiments, predicted equipment health status scores or metrics (e.g., MTTF, MTBF, MTTM, RULs of individual components, etc.) can be combined with corresponding estimated equipment health status scores or metrics using Bayesian inference to generate adjusted equipment health status scores or metrics.

Note that, in some embodiments, the adjusted equipment health status information can represent a current estimate of the health status of the manufacturing equipment that accounts for both normal deterioration of the equipment over time (e.g., based on the offline information) as well as a current status of the equipment (e.g., based on the real-time information).

As described above in connection with FIGS. 1A and 1B, the adjusted equipment health status information can include any suitable metrics. For example, metrics associated with a system or sub-system can include a MTTF, a MTTM, a MTBF, and/or any other suitable metrics. As another example, metrics associated with a particular component can include an RUL for the component.

Additionally, as discussed above in connection with FIGS. 1A and 1B, the adjusted equipment health status information can include any suitable prescriptive maintenance recommendations. For example, prescriptive maintenance recommendations can indicate that maintenance for a particular component should happen earlier than is currently scheduled. As another example, prescriptive maintenance recommendations can indicate that a particular component should be replaced as soon as possible. As yet another example, prescriptive maintenance recommendations can indicate that a particular component is likely to fail soon, and that replacement of a different component is likely to extend the life of the component identified as likely to fail soon. As still another example, prescriptive maintenance recommendations can indicate changes in a recipe implemented by the manufacturing equipment to extend the life of particular components.

As described above in connection with FIG. 2D, in some embodiments, prescriptive maintenance recommendations can be determined based in part on physics-based simulation values, for example, to identify parameters that can be modified to extend an RUL of a particular component.

At 330, the trained model can be updated to incorporate the adjusted equipment health status information. That is, the trained model can be updated such that the adjusted equipment health status information is used by the trained model in subsequent use of the trained model to incorporate the most recently collected data associated with the manufacturing equipment.

At 332, the process can end.

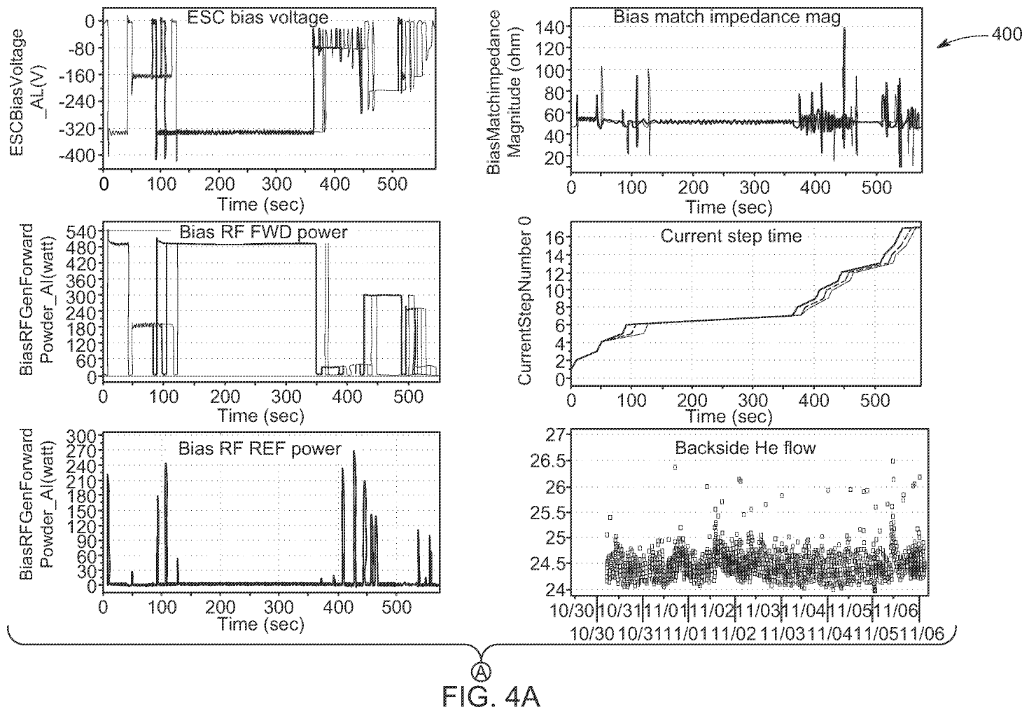

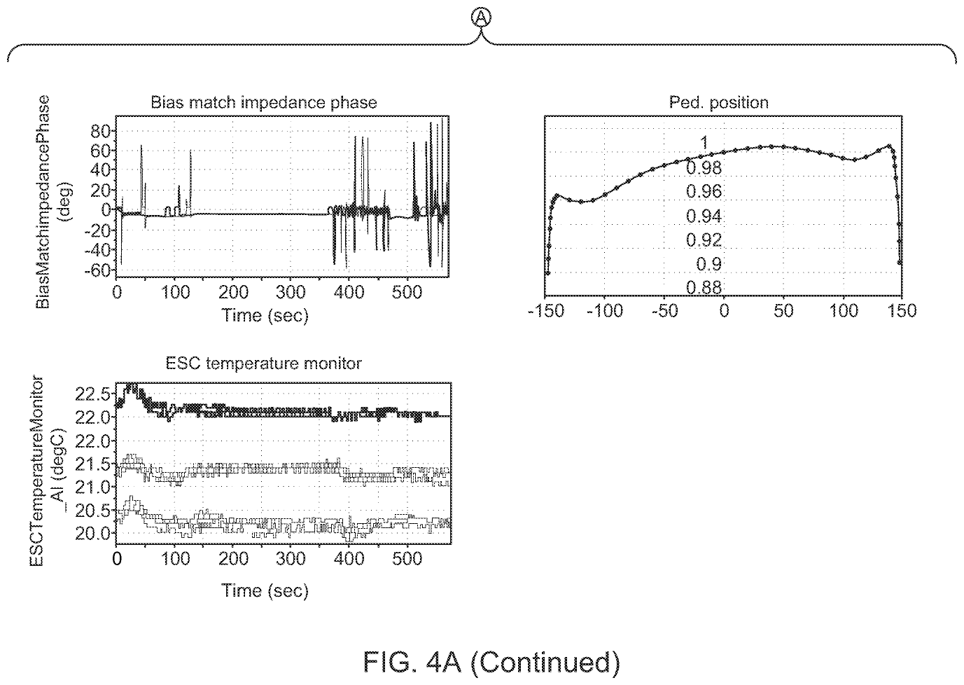

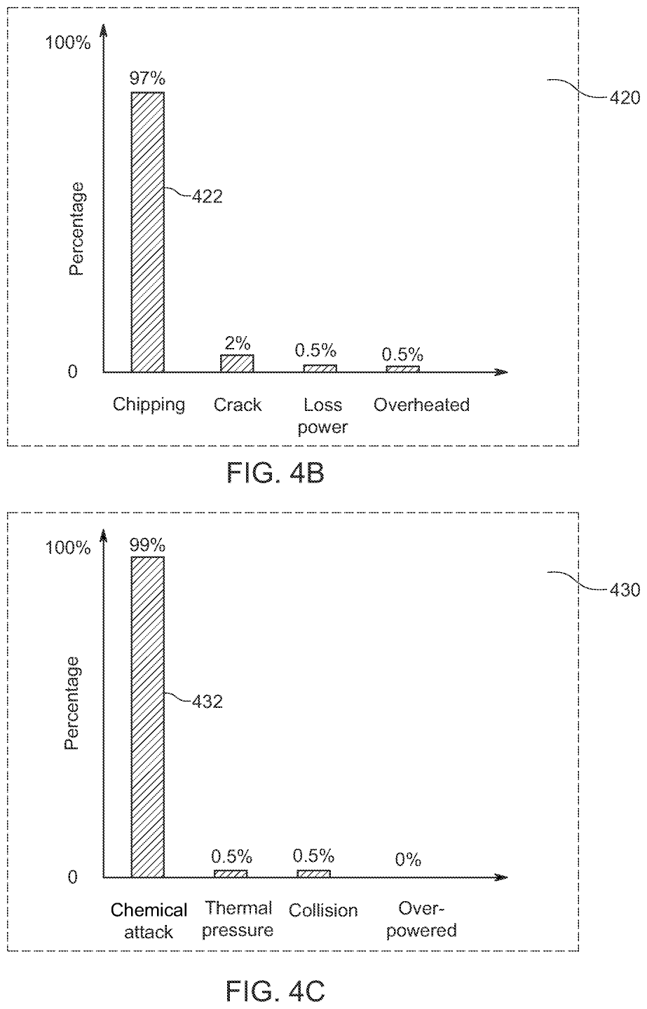

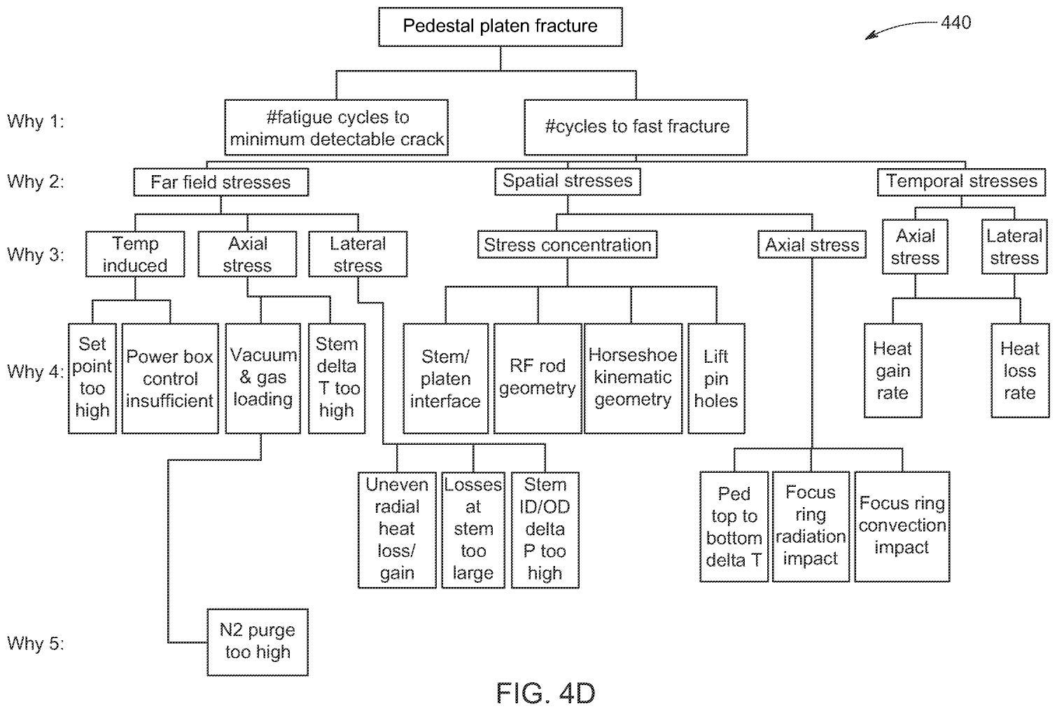

Examples of the techniques described above applied to a specific example of an ESC are now described hereinbelow in connection with FIGS. 4A, 4B, 4C, and 4D.

FIG. 4A shows example real-time data 400 associated with an ESC in accordance with some embodiments of the disclosed subject matter. As illustrated, the real-time data can include voltage measurements, impedance measurements, power measurements, gas flow measurements, temperature measurements, pedestal position measurements, and/or any other suitable measurements.

Turning to FIG. 4B, an example distribution of likely failures 420 is shown in accordance with some embodiments of the disclosed subject matter. In some embodiments, distribution of likely failures 420 can be generated by a failure isolation and analysis model (e.g., as shown in and described above in connection with FIG. 1B) in response to determining that an anomaly has been detected based on extracted features of real-time data 400.

As illustrated, distribution of likely failures 420 can include a set of potential failures, each with a corresponding likelihood that the failure is represented by real-time data 400. For examples, as illustrated in FIG. 4B, a potential failure 422 of chipping of a pedestal has been assigned a 97% likelihood, indicating that the anomaly detected in real-time data 400 has a 97% likelihood of representing chipping in the pedestal.

Turning to FIG. 4C, an example distribution of failure causes 430 is shown in accordance with some embodiments of the disclosed subject matter. Continuing with the example shown in and described above in connection with FIG. 4B, in an instance in which a most likely failure is pedestal chipping, distribution of failure causes 430 can indicate likely causes of the chipping. For example, as shown in FIG. 4C, the distribution of failure causes 430 can include a likely cause 432 of chemical attack, which has been assigned a 99% likelihood of being the cause of the chipping.

In some embodiments, distribution of failure causes 430 can be generated using the failure isolation and analysis model shown in and described above in connection with FIG. 1B. For example, in some embodiments, the failure isolation and analysis model can use any suitable knowledge database that indicates potential causes for different failures and that allows the failure isolation and analysis model to conduct a five why analysis to identify failure causes. Note that, in some embodiments, physics-based simulation values can be used in connection with the five why analysis to identify failure causes.

An example of a five why analysis 440 for a pedestal platen crack of an ESC is shown in FIG. 4D in accordance with some embodiments of the disclosed subject matter. As illustrated, the five why analysis can include a tree that can indicate different causes and sub-causes of a pedestal platen crack, with each hierarchy level of the tree addressing a different “why.” For example, a first level of the five why analysis can determine whether the pedestal platen crack is due to a fast fracture. Based on the analysis at the first level, the second level of the five why analysis can determine whether the cause is due to far-field stresses, spatial stresses, or temporal stresses. The five why analysis can be continued still further for any suitable number of levels to identify specific recipe parameters or component failures that contributed to the pedestal platen crack. Note that, although the five why analysis in FIG. 4D shows only one item in the fifth level indicating a root cause of the pedestal platen crack, in some embodiments, the fifth level can include any suitable number of items corresponding to any suitable number (e.g., five, ten, fifteen, twenty, etc.) of root causes of a failure.

In some embodiments, the predictive maintenance system can be used in connection with any other suitable system or sub-system of a process chamber.

For example, in some embodiments, the predictive maintenance system can be used in connection with a showerhead. With respect to a showerhead, the predictive maintenance system can receive data (e.g., real-time data signals and/or offline data signals) from sensors that indicate information related to the gap between a pedestal and the showerhead, a cooling control of the showerhead, a coolant valve position, a heater power status, a cooling overtemperature switch, a showerhead temperature, an output percentage, and/or any other suitable sensor data.

In some embodiments, the predictive maintenance system can identify any suitable anomalies or failures associated with the showerhead, such as flaking, peeling, anomalous levels of particles, unleveling, and/or any other suitable anomalies or failures. In some such embodiments, the predictive maintenance system can detect imminent failures (e.g., using the anomaly detection model described above) and/or potential future failures (e.g., by calculating RULs for different components associated with the showerhead).

In some embodiments, in response to detecting an anomaly or failure, the predictive maintenance system can identify any suitable root causes of the anomaly or failure. For example, an identified root cause can be a temperature control failure, clogged holes, an error in a setting of the gap between the showerhead and the pedestal, and/or any other suitable root cause. In some embodiments, root causes can be identified using a failure isolation and analysis model of the predictive maintenance system, as described above. More particularly, a five why analysis can be used to identify root causes, similar to what is described above in connection with FIG. 4D.

As another example, in some embodiments, the predictive maintenance system can be used in connection with an RF generator. The predictive maintenance system can receive data (e.g., real-time data signals and/or offline data signals) from sensors that indicate an RF match load position, RF generator compensated RF power, RF current, RF match peak to peak value, RF match tune position, a fan status, and/or any other suitable sensor data.

In some embodiments, the predictive maintenance system can identify any suitable anomalies or failures associated with the RF generator, such as excessive power, no power, RF noise, and/or any other suitable anomalies or failures. In some such embodiments, the predictive maintenance system can detect imminent failures (e.g., using the anomaly detection model described above) and/or potential future failures (e.g., by calculating RULs for different components associated with the RF generator).

In some embodiments, in response to detecting an anomaly or failure, the predictive maintenance system can identify any suitable root causes of the anomaly or failure. For example, an identified root cause can be a transistor failure, a Printed Circuit Board Assembly (PCBA) failure, arching, and/or any other suitable root cause. In some embodiments, root causes can be identified using a failure isolation and analysis model of the predictive maintenance system, as described above. More particularly, a five why analysis can be used to identify root causes, similar to what is described above in connection with FIG. 4D.

In some embodiments, the predictive maintenance system can be used to identify ways to reuse particular components. For example, in an instance in which a particular component is identified as having a particular RUL below a predetermined threshold (e.g., less than ten days, less than twenty days, etc.) when used in a particular piece of manufacturing equipment, the predictive maintenance system can determine whether the component can be used in a different piece of manufacturing equipment. As a more particular example, in an instance in which a pedestal of a process chamber is identified as having an RUL below a predetermined threshold, the predictive maintenance system can then determine whether the pedestal can be used in a different process chamber, such as an older model, a model that runs different recipes, etc. Other examples of components that can be reused can include heating elements, robot motors, electronic boards, computers, pressure regulators, gas lines, valves and/or Mass Flow Controllers (MFCs) associated with inert gases (argon, helium, etc.) and/or non-toxic gases (e.g., Hz, etc.), and/or any other suitable components.

In some embodiments, the predictive maintenance system can determine whether a particular component can be repurposed by using the component in a different, second item of manufacturing equipment by using the predictive maintenance system to evaluate an equipment health status of the second item of manufacturing equipment when the component is used. For example, a newer model of a process chamber may operate at a higher temperature, thereby causing acceleration of one or more failure modes, whereas an older model of the process chamber may operate at a lower temperature, thereby prolonging a life of a particular component. As a more particular example, the predictive maintenance system can evaluate the equipment health status of an older model of a process chamber when using a pedestal that has been identified as likely to fail when used in a newer model of a process chamber.

As a specific example, the predictive maintenance system can generate RULs for different components of the older model of the process chamber, MTTF or MTTM metrics for systems of the older model of the process chamber, etc. In some embodiments, in response to calculating improved equipment health status metrics when a component is used in a different item of manufacturing equipment, the predictive maintenance system can identify that the component can be reused elsewhere to prolong a lifecycle of the component. For example, in some embodiments, in response to determining that an RUL of a component would be increased when the component is used in an older model of a process chamber relative to when used in the current equipment, the predictive maintenance system can generate and present a recommendation that the component should be removed from the current equipment and used in the older model of the process chamber.

In some embodiments, by identifying ways to reuse components, components can be reused and/or recycled, thereby extending a lifecycle of the component.

### Applications

A predictive maintenance system as described herein may improve efficiency of semiconductor manufacturing equipment by reducing downtime of equipment due to unforeseen anomalies in equipment (e.g., broken components) and by reducing the need for manual inspection and troubleshooting.

For example, by calculating a time until specific systems or components require maintenance, the predictive maintenance system can provide continual updates on a status of a system that can allow replacement components to be ordered in time and/or for maintenance to be scheduled prior to equipment problems.

As another example, by generating prescriptive maintenance recommendations, the predictive maintenance system can identify temporary solutions to an identified upcoming likely failure of a component that can allow manufacturing equipment to continue to be used until maintenance can be performed, thereby reducing downtime of the manufacturing equipment.

As yet another example, by identifying probable failures associated with a detected anomaly during an imminent failure, and by identifying likely causes of a failure, the predictive maintenance system can reduce the number of manual troubleshooting hours required to identify root causes of failures.

### Context for Disclosed Computational Embodiments

Certain embodiments disclosed herein relate to computational systems for generating and/or using machine learning models for predictive maintenance systems. Certain embodiments disclosed herein relate to methods for generating and/or using a machine learning model implemented on such computational systems. A computational system for generating a machine learning model may also be configured to receive data and instructions such as program code representing physical processes occurring during the semiconductor device fabrication operation. In this manner, a machine learning model is generated or programmed on such system.

Many types of computing systems having any of various computer architectures may be employed as the disclosed systems for implementing machine learning models and algorithms for generating and/or optimizing such models. For example, the systems may include software components executing on one or more general purpose processors or specially designed processors such as Application Specific Integrated Circuits (ASICs) or programmable logic devices (e.g., Field Programmable Gate Arrays (FPGAs)). Further, the systems may be implemented on a single device or distributed across multiple devices. The functions of the computational elements may be merged into one another or further split into multiple sub-modules.

In some embodiments, code executed during generation or execution of a machine learning model on an appropriately programmed system can be embodied in the form of software elements which can be stored in a nonvolatile storage medium (such as optical disk, flash storage device, mobile hard disk, etc.), including a number of instructions for making a computer device (such as personal computers, servers, network equipment, etc.).

At one level a software element is implemented as a set of commands prepared by the programmer/developer. However, the module software that can be executed by the computer hardware is executable code committed to memory using “machine codes” selected from the specific machine language instruction set, or “native instructions,” designed into the hardware processor. The machine language instruction set, or native instruction set, is known to, and essentially built into, the hardware processor(s). This is the “language” by which the system and application software communicates with the hardware processors. Each native instruction is a discrete code that is recognized by the processing architecture and that can specify particular registers for arithmetic, addressing, or control functions; particular memory locations or offsets; and particular addressing modes used to interpret operands. More complex operations are built up by combining these simple native instructions, which are executed sequentially, or as otherwise directed by control flow instructions.

The inter-relationship between the executable software instructions and the hardware processor is structural. In other words, the instructions per se are a series of symbols or numeric values. They do not intrinsically convey any information. It is the processor, which by design was preconfigured to interpret the symbols/numeric values, which imparts meaning to the instructions.

The models used herein may be configured to execute on a single machine at a single location, on multiple machines at a single location, or on multiple machines at multiple locations. When multiple machines are employed, the individual machines may be tailored for their particular tasks. For example, operations requiring large blocks of code and/or significant processing capacity may be implemented on large and/or stationary machines.

In addition, certain embodiments relate to tangible and/or non-transitory computer readable media or computer program products that include program instructions and/or data (including data structures) for performing various computer-implemented operations. Examples of computer-readable media include, but are not limited to, semiconductor memory devices, phase-change devices, magnetic media such as disk drives, magnetic tape, optical media such as CDs, magneto-optical media, and hardware devices that are specially configured to store and perform program instructions, such as read-only memory devices (ROM) and random access memory (RAM). The computer readable media may be directly controlled by an end user or the media may be indirectly controlled by the end user. Examples of directly controlled media include the media located at a user facility and/or media that are not shared with other entities. Examples of indirectly controlled media include media that is indirectly accessible to the user via an external network and/or via a service providing shared resources such as the “cloud.” Examples of program instructions include both machine code, such as produced by a compiler, and files containing higher level code that may be executed by the computer using an interpreter.

In various embodiments, the data or information employed in the disclosed methods and apparatus is provided in an electronic format. Such data or information may include design layouts, fixed parameter values, floated parameter values, feature profiles, metrology results, and the like. As used herein, data or other information provided in electronic format is available for storage on a machine and transmission between machines. Conventionally, data in electronic format is provided digitally and may be stored as bits and/or bytes in various data structures, lists, databases, etc. The data may be embodied electronically, optically, etc.

In some embodiments, a machine learning model can each be viewed as a form of application software that interfaces with a user and with system software. System software typically interfaces with computer hardware and associated memory. In some embodiments, the system software includes operating system software and/or firmware, as well as any middleware and drivers installed in the system. The system software provides basic non-task-specific functions of the computer. In contrast, the modules and other application software are used to accomplish specific tasks. Each native instruction for a module is stored in a memory device and is represented by a numeric value.

An example computer system 500 is depicted in FIG. 5. As shown, computer system 500 includes an input/output subsystem 502, which may implement an interface for interacting with human users and/or other computer systems depending upon the application. Embodiments of the disclosure may be implemented in program code on system 500 with I/O subsystem 502 used to receive input program statements and/or data from a human user (e.g., via a GUI or keyboard) and to display them back to the user. The I/O subsystem 502 may include, e.g., a keyboard, mouse, graphical user interface, touchscreen, or other interfaces for input, and, e.g., an LED or other flat screen display, or other interfaces for output.

Communication interfaces 507 can include any suitable components or circuitry used for communication using any suitable communication network (e.g., the Internet, an intranet, a wide-area network (WAN), a local-area network (LAN), a wireless network, a virtual private network (VPN), and/or any other suitable type of communication network). For example, communication interfaces 507 can include network interface card circuitry, wireless communication circuitry, etc.

Program code may be stored in non-transitory media such as secondary memory 510 or memory 508 or both. In some embodiments, secondary memory 510 can be persistent storage. One or more processors 504 reads program code from one or more non-transitory media and executes the code to enable the computer system to accomplish the methods performed by the embodiments herein, such as those involved with generating or using a process simulation model as described herein. Those skilled in the art will understand that the processor may accept source code, such as statements for executing training and/or modelling operations, and interpret or compile the source code into machine code that is understandable at the hardware gate level of the processor. A bus 505 couples the I/O subsystem 502, the processor 504, peripheral devices 506, communication interfaces 507, memory 508, and secondary memory 810.

### CONCLUSION

In the description, numerous specific details were set forth in order to provide a thorough understanding of the presented embodiments. The disclosed embodiments may be practiced without some or all of these specific details. In other instances, well-known process operations were not described in detail to not unnecessarily obscure the disclosed embodiments. While the disclosed embodiments were described in conjunction with the specific embodiments, it will be understood that the specific embodiments are not intended to limit the disclosed embodiments.

Unless otherwise indicated, the method operations and device features disclosed herein involves techniques and apparatus commonly used in metrology, semiconductor device fabrication technology, software design and programming, and statistics, which are within the skill of the art.

Unless defined otherwise herein, all technical and scientific terms used herein have the same meaning as commonly understood by one of ordinary skill in the art. Various scientific dictionaries that include the terms included herein are well known and available to those in the art. Although any methods and materials similar or equivalent to those described herein find use in the practice or testing of the embodiments disclosed herein, some methods and materials are described.

Numeric ranges are inclusive of the numbers defining the range. It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The headings provided herein are not intended to limit the disclosure.

As used herein, the singular terms “a,” “an,” and “the” include the plural reference unless the context clearly indicates otherwise. The term “or” as used herein, refers to a non-exclusive or, unless otherwise indicated.

1. A predictive maintenance system, comprising:
a memory; and
a processor that, when executing computer-executable instructions stored in the memory, is configured to:
receive offline data that indicates historical operating conditions and historical manufacturing information corresponding to manufacturing equipment that conducts a manufacturing process;
calculate predicted equipment health status information associated with the manufacturing equipment by using a trained model that takes the offline data as an input;
receive real-time data that indicates current operating conditions and current manufacturing information corresponding to the manufacturing equipment;
calculate estimated equipment health status information associated with the manufacturing equipment by using the trained model that takes the real-time data as an input;
calculate adjusted equipment health status information associated with the manufacturing equipment by combining the predicted equipment health status information calculated based on the offline data and the estimated equipment health status information calculated based on the real-time data; and
present the adjusted equipment health status information, wherein the adjusted equipment health status information includes an expected remaining useful life (RUL) of at least one component of the manufacturing equipment.

2. The predictive maintenance system of claim 1, wherein the offline data that indicates historical operating conditions and the real-time data that indicates current operating conditions comprises data received from one or more sensors of the manufacturing equipment.

3. The predictive maintenance system of claim 1, wherein the model is trained using physics-based simulation data.

4. The predictive maintenance system of claim 3, wherein the physics-based simulation data comprises estimated data at a first spatial location of the manufacturing equipment that is estimated based on measured sensor data at one or more other spatial locations of the manufacturing equipment at which physical sensors are located.

5. The predictive maintenance system of claim 1, wherein the estimated data is an interpolation of the measured sensor data.

6. The predictive maintenance system of claim 1, wherein the model is trained using metrology data associated with substrates comprising electronic devices fabricated using the manufacturing process.

7. The predictive maintenance system of claim 1, wherein the processor is further configured to extract features of the offline data that indicates historical operating conditions and of the real-time data that indicates current operating conditions, and wherein the trained model takes the extracted features as inputs.

8. The predictive maintenance system of claim 1, wherein the processor is further configured to:
detect an anomalous condition of the manufacturing equipment based on the real-time data that indicates current operating conditions; and
in response to detecting the anomalous condition of the manufacturing equipment, identify a type of failure associated with the manufacturing equipment.

9. The predictive maintenance system of claim 8, wherein detecting the anomalous condition of the manufacturing equipment is based on a comparison of the real-time data that indicates current operating conditions and the offline data that indicates historical operating conditions.

10. The predictive maintenance system of claim 8, wherein identifying the type of failure associated with the manufacturing equipment comprises classifying the real-time data that indicates current operating conditions using a historical failure database.

11. The predictive maintenance system of claim 8, wherein identifying the type of failure associated with the manufacturing equipment comprises classifying the real-time data that indicates current operating conditions using physics-based simulation data.

12. The predictive maintenance system of claim 1, wherein the processor is further configured to:
identify a modification of the current operating conditions of the manufacturing equipment and a likelihood that the modification in the current operating conditions will change the expected remaining useful life of the at least one component of the manufacturing equipment; and
present the identified modification of the current operating conditions.

13. The predictive maintenance system of claim 12, wherein the modification of the current operating conditions of the manufacturing equipment is identified based on physics-based simulation data.

14. The predictive maintenance system of claim 1, wherein the processor is further configured to:
calculate second adjusted equipment health status information associated with second manufacturing equipment that conducts the manufacturing process, wherein the second adjusted equipment health status information is based on the second manufacturing equipment having the at least one component of the manufacturing equipment; and
presenting a recommendation to remove the at least one component from the manufacturing equipment to use in the second manufacturing equipment based on the second adjusted equipment health status information.

15. The predictive maintenance system of claim 14, wherein the second adjusted equipment health status information is calculated in response to determining that the RUL of the at least one component is below a predetermined threshold.

16. The predictive maintenance system of claim 15, wherein the recommendation is presented in response to determining that a second RUL corresponding to the at least one component when used in the second manufacturing equipment exceeds the RUL of the at least one component when used in the manufacturing equipment.

17. A predictive maintenance system, comprising:
a memory; and
a processor that, when executing computer-executable instructions stored in the memory, is configured to:
receive offline data that indicates historical operating conditions and historical manufacturing information corresponding to manufacturing equipment that conducts a manufacturing process, wherein the offline data comprises offline sensor data from a plurality of sensors associated with the manufacturing equipment;
generate a plurality of physics-based simulation values using one or more physics-based simulation models that each model a component of the manufacturing equipment;
train a neural network that generates a predicted equipment health status score using the offline data and the plurality of physics-based simulation values.

18. The predictive maintenance system of claim 17, wherein each training sample used to train the neural network comprises the offline data and the plurality of physics-based simulation values as input values and metrology data as a target output.

19. The predictive maintenance system of claim 17, wherein a physics-based simulation value of the plurality of physics-based simulation value is an estimation of a measurement corresponding to a sensor of the plurality of sensors.

20. The predictive maintenance system of claim 19, wherein the sensor of the plurality of sensors is located at a first position of the manufacturing equipment, and wherein the estimation of the measurement is at a second position of the manufacturing equipment.

21. The predictive maintenance system of claim 17, wherein the historical manufacturing information comprises Failure Mode and Effects Analysis (FMEA) information corresponding to the manufacturing equipment.

22. The predictive maintenance system of claim 17, wherein the historical manufacturing information comprises design information related to the manufacturing equipment.

23. The predictive maintenance system of claim 17, wherein the historical manufacturing information comprises quality information retrieved from a quality database.
